(19) United States
(12) Patent Application Publication
(10) Pub. No.: US 2015/0062220 A1
(43) Pub. Date: Mar. 5, 2015

(54) LIQUID EJECTING APPARATUS, PRINT HEAD UNIT, AND DRIVE SUBSTRATE

(71) Applicant: Seiko Epson Corporation, Tokyo (JP)

(72) Inventors: Toru KASHIMURA, Shiojiri (JP); Hiroshi SUGITA, Shiojiri (JP)

(21) Appl. No.: 14/459,649

(22) Filed: Aug. 14, 2014

(30) Foreign Application Priority Data
Aug. 30, 2013 (JP) 2013-179665
Jun. 26, 2014 (JP) 2014-131048

(51) Int. Cl. B41J 2/045

(52) U.S. Cl. CPC B41J 2/04541; B41J 2/04581
USPC 347/10

(57) ABSTRACT

A plurality of THs are formed in the main substrate (drive substrate) in a region in which switching transistors are disposed. In addition, a solid pattern obtained by expanding an interconnection pattern at the periphery of the transistors is formed to surround the transistors. In addition, a solid pattern for heat dissipation is also formed on a rear surface to add a heat dissipation structure for a frame. According to this, it is possible to provide a liquid ejecting apparatus which has a simple configuration and which realizes operation stability without using a dedicated heat dissipation component.

The entire disclosures of Japanese Patent Application Nos. 2013-179665, filed Aug. 30, 2013 and No. 2014-131048, filed Jun. 26, 2014 are expressly incorporated by reference herein.

### BACKGROUND

1. Technical Field

The present invention relates to a liquid ejecting apparatus, a print head unit including an ejection unit that is provided to the liquid ejecting apparatus, and a drive substrate that drives the ejection unit.

2. Related Art

As a liquid ejecting apparatus such as an ink jet printer, there is known a liquid ejecting apparatus that uses a piezoelectric element as an actuator that ejects ink droplets. To drive the piezoelectric element, it is necessary to apply a drive signal having a vibration range of several tens of volts as a peak value. In the related art, an analog amplifier, in which a bipolar transistor is push-pull connected, is mounted on a drive substrate that generates the driving signal. In the bipolar transistor, when a collector current increases, heat is generated in proportion to the increase. Therefore, in the liquid ejecting apparatus in which a large current and a high voltage are applied between an emitter and a collector to drive multiple capacitive loads, power conversion efficiency is poor and an amount of heat generation is large, and thus there is a problem in that a heat sink for heat dissipation is necessary.

In consideration of the above-described problem, the present inventors suggest employing a digital amplification that uses a metal-oxide-semiconductor field-effect transistor (MOSFET) that is more excellent in power conversion efficiency in comparison to the analog amplifier (for example, JP-A-2011-5733). In the digital amplifier using the MOSFET, a pulse modulation technology is used, and thus the power conversion efficiency is more excellent in comparison to the analog amplifier, and thus heat generation can also be suppressed. The reason of using the MOSFET instead of the bipolar transistor is that it is possible to cope with a high-speed switching operation demanded for the digital amplifier. For example, it is necessary to reduce a base width so as to switch the bipolar transistor at a high speed. However, the reduction of the base width is apt to lead to a deterioration in withstanding pressure due to punch-through, and thus it is difficult to apply a high voltage for sufficient liquid ejection between an emitter and a connector. That is, the reduction of the base width is poor in feasibility, and thus it is difficult to employ the bipolar transistor.

However, to realize stable liquid droplet ejection by using the digital amplifier, there is demanded a high resolution for amplifying a modulation signal including a frequency component that is several tens of times a frequency component included in a drive signal that is applied to the piezoelectric element for ejection of the liquid droplets. Therefore, a high-frequency operation is necessary, and thus there is a problem in that heat generation at a considerable level is apt to occur. An amount of heat generation in the digital amplifier is caused by switching loss accompanying the high-frequency operation for realizing the high resolution. In a case of only ejecting liquid droplets, the amount of heat generation is at a level in which it is not necessary to use a heat sink. However, in a case of constantly stabilizing an amount of the liquid droplets that are ejected while securing a stable circuit operation, it can be said that the amount of heat generation is at a level for which an arbitrary heat dissipation countermeasure is necessary. Actually, when consideration is given based on a drive signal for ejecting an ink, a modulation single becomes a signal in the order of MHz, and thus it is also necessary for the digital amplifier to be driven in the order of MHz. Due to the high-frequency operation, there is a problem in that heat generation due to a switching loss of a switching element occurs at a considerable level.

In addition, there is a demand for miniaturization of the liquid droplet ejecting apparatus, and thus an arbitrary heat dissipation countermeasure is necessary, but there is a problem in that addition of a dedicated heat dissipation component or an increase in the size of the dedicated heat dissipation component is difficult.

### SUMMARY

The invention can be realized in the following forms or application examples.

### APPLICATION EXAMPLES

According to an aspect of the invention, there is provided a liquid ejecting apparatus including an A/D converter that performs pulse modulation of an original drive signal at a high frequency region to generate a modulation signal, a transistor that amplifies the modulation signal to generate an amplified modulation signal, a filter circuit that smooths the amplified modulation signal to generate a drive signal, an ejection unit that is subjected to an ejection operation by the drive signal to eject liquid droplets, and a substrate on which at least the transistor is disposed. Through-holes are formed in the substrate in a region in which the transistor is disposed.

According to this configuration, even though including a drive circuit that performs a high-frequency operation, it is possible to secure an expected heat dissipation performance with a simple configuration in which through-holes are formed in a region in which a transistor is disposed without using a dedicated heat dissipation component such as a heat sink. Accordingly, it is possible to constantly stabilize an amount of liquid droplets to be ejected while securing operation stability of the drive circuit.

Accordingly, it is possible to provide a liquid ejecting apparatus which realizes stabilization in an amount of liquid droplets that are ejected and operation stability with a simple configuration without using a dedicated heat dissipation component.

In addition, the original drive signal represents a signal that is a source of a drive signal that drives an ejection unit to eject a liquid droplet, that is, a reference signal before modulation. The modulation signal represents a digital signal that is obtained by subjecting the original drive signal to pulse modulation (for example, pulse width modulation, pulse density modulation, and the like). The amplified modulation signal represents a modulation signal that is amplified by an amplification circuit including a transistor. The drive signal represents a signal which is obtained by smoothing the amplified modulation signal by using a coil and which is applied to an ejection unit.

In addition, it is preferable that a frequency band of an AC component included in the modulation signal or the amplified modulation signal be 1 MHz or higher.

In the liquid ejecting apparatus of this application example, the amplified modulation signal is smoothed to generate a drive signal, and a liquid is ejected from a nozzle based on deformation of a piezoelectric element to which a drive signal is applied. Here, when a waveform of a drive signal used by the liquid ejecting apparatus to eject a small dot is subject to frequency spectrum analysis, it can be seen that a frequency component of 50 kHz or lower is included. To amplify an original drive signal including the frequency component of 50 kHz with the digital amplifier, a modulation signal including a frequency component of 1 MHz or higher is necessary. When reproducing the original drive signal only with a frequency component of 1 MHz or lower, an edge of a waveform becomes dull and is rounded. In other words, a waveform in which a corner is removed becomes dull. When the waveform of the drive signal becomes dull, movement of the piezoelectric element that operates along with a rising edge and a falling edge of a waveform gradually occurs, and thus an unstable operation such as tailing during ejection and an ejection failure is apt to occur. In the liquid ejecting apparatus of this application example, since the frequency band of the AC component of the amplified modulation signal is set to 1 MHz or higher, an unstable operation such as the tailing during ejection and the ejection failure does not occurs, and thus it is possible to realize a liquid ejecting apparatus capable of obtaining a high-resolution product.

In addition, it is preferable that the frequency band of the AC component included in the modulation signal or the amplified modulation signal be lower than 8 MHz.

A high frequency of 8 MHz or higher is supported as a frequency of the amplified modulation signal, resolution of a waveform of the drive signal increases, but a switching frequency in a digital amplifier is raised along with an improvement in the resolution. When the switching frequency is raised, switching loss increases. Therefore, power saving properties and low heat-generation properties of the digital amplifier which are superior to that of an analog amplifier (AB-grade amplifier) may be damaged, and thus amplification by the AB-grade amplifier may be superior to that of the digital amplifier in some cases. In the liquid ejecting apparatus of this application example, the frequency band of the AC component of the amplified modulation signal is set to be lower than 8 MHz, it is possible to maintain the superiority in the power saving properties and the low heat-generation properties in comparison to a case of using the AB-grade amplifier.

In addition, it is preferable that the number of the through-holes be more than the number of mounting terminals that mount the transistor one the substrate.

According to simulation results obtained by the present inventors, it can be seen that the more the number of the through-holes is, the higher the heat dissipation effect becomes. Accordingly, in a circuit scale of a drive circuit provided with a switching circuit including a switching transistor, and a filter circuit, heat dissipation through-holes are additionally provided even in an interconnection scale capable of being interconnected in a single-sided substrate in which the through-holes are not necessary, thereby securing an expected heat dissipation performance. In other words, through-holes are formed in the number more than necessary in the interconnection scale to increase heat dissipation properties, thereby securing an expected heat dissipation performance.

In addition, it is preferable that the number of the through-holes be more than the number of through-holes that are necessary to interconnect the transistor and the filter circuit to the substrate.

According to simulation results obtained by the present inventors, it can be seen that the more the number of the through-holes is, the higher the heat dissipation effect becomes. Accordingly, when providing more through-holes, it is possible to increase a heat dissipation effect.

In addition, it is preferable that the number of the through-holes be 10 or more.

According to simulation results obtained by the present inventors, it can be seen that the more the number of the through-holes is, the higher the heat dissipation effect becomes. Accordingly, when providing more through-holes, it is possible to increase a heat dissipation effect.

In addition, it is preferable that the through-holes be formed in a first interconnection that extends from each of the mounting terminals in the transistor.

To form the through-holes in the first interconnection that extends from the mounting terminal in the transistor, it is necessary to increase an area of the first interconnection. As the area increases, a surface area of the first interconnection formed from metal foil increases. Accordingly, the first interconnection itself also functions as a heat dissipation plate (heat sink). Accordingly, a heat dissipation effect can be increased.

In addition, it is preferable that a solid pattern region, which is broader than the mounting terminal, be formed in the first interconnection, and the through-holes be formed in the solid pattern region.

The broader an area of the first interconnection is, the broader a surface area is. Accordingly, it is possible to increase a heat dissipation effect to the air. According to this, it is possible to further increase the heat dissipation effect.

In addition, it is preferable that an area of the solid pattern region be broader than a plane area of the transistor.

The broader the area of the first interconnection is, the further the surface increase. Accordingly, it is possible to increase the heat dissipation effect to the air. According to this, it is possible to further increase the heat dissipation effect.

In addition, it is preferable that the substrate be a double-sided substrate, the transistor and the filter circuit be mounted on a first surface of the substrate, and a second interconnection, which is connected to the first interconnection through the through-holes, be formed on a second surface that is opposite to the first surface.

In a case of the double-sided substrate, the second interconnection is also formed on the second surface in addition to the first interconnection that is a heat dissipation plate of the first surface, and the second interconnection also functions as a heat dissipation plate. Accordingly, it is possible to further increase the heat dissipation effect.

In addition, it is preferable that an area of the second interconnection be broader than the plane area of the transistor.

The broader the area of the second interconnection is, the broader a surface area is. Accordingly, it is possible to increase a heat dissipation effect to the air. According to this, it is possible to further increase the heat dissipation effect.

In addition, it is preferable that the liquid ejecting apparatus further include a casing body and a frame of the casing body, the substrate be mounted on the frame in a state in which the second surface faces the frame, and a heat transfer member be interposed between the frame and the substrate.

According to this configuration, the substrate is mounted on the frame of the casing through the heat conductive member. That is, the substrate is thermally coupled to a metal frame, and thus heat generated in the substrate is effectively transferred to the frame and is dissipated. Accordingly, it is possible to further increase the heat dissipation effect.

In addition, it is preferable that the ejection unit include a piezoelectric element, a pressure chamber which is filled with a liquid and in which an inner pressure increases or decreases due to displacement of the piezoelectric element, and a nozzle which communicates with the pressure chamber and ejects the liquid as the liquid droplet due to the increase and decrease in the pressure inside the pressure chamber.

A liquid ejection type is largely classified into a thermal type in which a liquid filled in the pressure chamber is heated by allowing a current to flow through a resistive element such as a heater, and the liquid is ejected by transferring the thermal energy to the liquid, a piezo type in which at least a part of a wall surface inside the pressure chamber is designed to be displaceable, and a volume inside the pressure chamber is caused to vary by displacing the wall surface using displacement of a piezoelectric element that displaces when a voltage is applied thereto, thereby ejecting the liquid filled in the pressure chamber, and the like. However, heat generation in an amplification circuit including a transistor is larger in the piezo type in comparison to the thermal type when considering that a large voltage variation accompanied by ejection of the liquid is necessary, and thus it is possible to strongly have the effect of the invention.

According to another aspect of the invention, there is provided a drive substrate including an A/D converter that performs pulse modulation of an original drive signal at a high frequency region to generate a modulation signal, a transistor that amplifies the modulation signal to generate an amplified modulation signal, a filter circuit that smooths the amplified modulation signal to generate a drive signal, and a substrate on which at least the transistor is disposed. Through-holes are formed in the substrate in a region in which the transistor is disposed.

According to still another aspect of the invention, there is provided a printer head unit including an A/D converter that performs pulse modulation of an original drive signal at a high frequency region to generate a modulation signal, a transistor that amplifies the modulation signal to generate an amplified modulation signal, a filter circuit that smooths the amplified modulation signal to generate a drive signal, an ejection unit that is subjected to an ejection operation by the drive signal to eject liquid droplets, and a substrate on which at least the transistor is dispose. Through-holes are formed in the substrate in a region in which the transistor is disposed.

### BRIEF DESCRIPTION OF THE DRAWINGS

The invention will be described with reference to the accompanying drawings, wherein like numbers reference like elements.

FIG. 1 is a perspective view illustrating an overview of a liquid ejecting apparatus according to Embodiment 1.

FIG. 2 is a view schematically illustrating a printing mechanism.

FIG. 3 is a plan view of a nozzle plate;

FIG. 4 is a cross-sectional view taken along line IV-IV in FIG. 3.

FIG. 5 is a block diagram illustrating a configuration of a control circuit of a printer.

FIG. 6 is a block diagram illustrating a configuration a drive circuit.

FIG. 7 is a view illustrating an example of a drive signal and printing data.

FIG. 8 is a spectrum analysis diagram of an original drive signal.

FIG. 9 is a circuit block diagram of a head substrate;

FIG. 10 is a plan view of a surface of a drive circuit region in a main substrate.

FIG. 11 is a plan view illustrating an interconnection scale of the drive circuit.

FIG. 12 is a plan view illustrating a heat generation distribution of the drive circuit.

FIG. 13 is a view illustrating a substrate setting in a simulation.

FIG. 14 is a graph illustrating heat dissipation characteristics with respect to a rear surface of a substrate.

FIG. 15 is an enlarged view of a switching circuit mounting region in FIG. 10.

FIG. 16 is a plan view of a rear surface in a main substrate.

FIG. 17 is a cross-sectional view illustrating an aspect of a heat dissipation structure to a frame.

FIG. 18 is a schematic configuration view of a different ejection unit.

FIG. 19 is a schematic configuration view of a different ejection unit.

FIG. 20 is a schematic configuration view of a different ejection unit.

### DESCRIPTION OF EXEMPLARY EMBODIMENTS

Hereinafter, embodiments of the invention will be described with reference to the attached drawings. In addition, in the respective drawings, reduced scales of respective layers or respective portions are made to be different from actual scales so as to make the respective layers or the respective portions have a recognizable size in the drawings.

### Embodiment 1

### Overview of Liquid Ejecting Apparatus

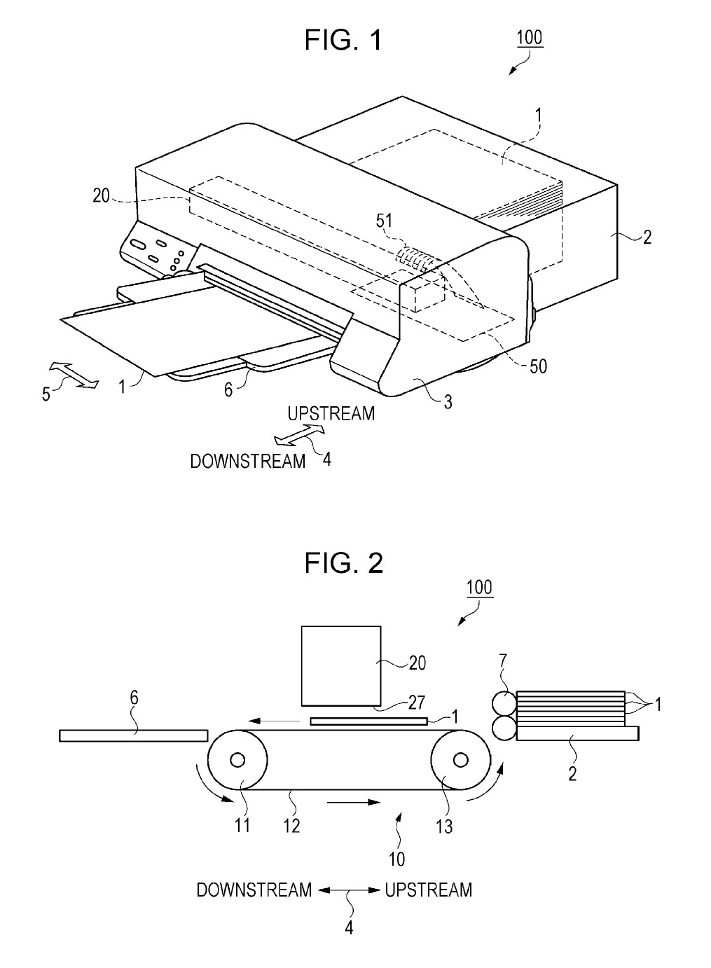

FIG. 1 is a perspective view illustrating an overview of a liquid ejecting apparatus according to Embodiment 1. First, an overview of a printer 100 as the liquid ejecting apparatus according to this embodiment will be described.

The printer 100 is an ink jet type printer that performs printing by using a print head unit 20 with respect to a sheet of paper 1 as a printing medium fed from a paper feeding tray 2 on a rear surface side, and discharges the sheet of paper 1 toward a paper discharging tray 6 on a front surface side. In addition, in the following description, a direction in which the sheet of paper 1 is transported is referred to as a transportation direction 4, and a direction (a width direction of the sheet of paper 1) intersecting the transportation direction is referred to as a paper width direction 5. In addition, in the transportation direction 4, a paper feeding tray 2 side is referred to as an upstream side, and a discharge (front surface) side is referred to as a downstream side.

The print head unit 20 is provided with a line head, and can complete the printing with a so-called single pass in which scanning (reciprocal operation) in the paper width direction 5 is not performed and the printing is performed only with a sheet of paper 1 transporting operation to the transportation direction 4. On the print head unit 20, a black ink is also mounted in addition to three columns of line heads corresponding to a plurality of colors (cyan, magenta, yellow, light cyan, light magenta, and the like) of inks, and thus the print head unit 20 is provided with a total of four line heads. Although details will be described later, a plurality of print head modules are disposed at each of the line heads at a constant pitch across the width direction (paper width direction 5) of the sheet of paper 1.

A plurality of flexible printed circuits (FPC) 51 are connected to the print head unit 20. The FPC 51 supplies a control single such as a drive signal for an ejection operation of a plurality of ejection units and a timing signal to the print head unit 20 from a main substrate 50. Here, a drive circuit that generates the drive signal is mounted on the main substrate 50. The drive circuit employs a digital amplifier (amplification circuit) excellent in power conversion efficiency, but heat generation due to switching loss of a switching element is apt to occur at a considerable level. In the printer 100, a plurality of through-holes are formed in a drive circuit region of the main substrate 50 to dissipate the generated heat. In addition, the main substrate 50 is fixed to a metal frame (not shown) of a case 3 to increase a heat dissipation effect, thereby realizing a stable operation. Hereinafter, these configurations will be described in detail.

FIG. 2 is a view schematically illustrating a printing mechanism.

Subsequently, an overview of the printing mechanism and a printing flow will be described.

The printing mechanism of the printer 100 includes the paper feeding tray 2, a paper feeding roller 7, a transportation unit 10, the print head unit 20, the paper discharging tray 6, and the like.

The paper feeding roller 7 represents a pair of rollers provided on a downstream side of the paper feeding tray 2, and feeds the sheet of paper 1 on the paper feeding tray 2 one by one to the transportation unit 10.

The transportation unit 10 includes a transportation drive roller 11, a transportation belt 12, a driven roller 13, and the like. The transportation belt 12 is wound (stretched) between (at the outer periphery of) the transportation drive roller 11 and the driven roller 13. The transportation belt 12 is a strip-shaped belt. As indicated by an arrow, the transportation belt 12 mounts the sheet of paper 1 supplied from the paper feeding roller 7 thereon, and transmits the sheet of paper 1 to a downstream side along with rotation of the transportation drive roller 11.

The transportation belt 12 is provided with a suction device that suctions the sheet of paper 1 on a surface of the transportation belt 12, a position detection device that detects a position of the sheet of paper 1 in the transportation direction 4 (all of these are not shown), and the like. As the suction device, an air suction device that suctions the sheet of paper 1 by using a negative pressure of air, an electrostatic suction device that suctions the sheet of paper 1 by using an electrostatic force, and the like are used. As the position detection device, a linear encoder and the like are used.

An electric motor (not shown) is connected to the transportation drive roller 11. The electric motor rotates in response to a control signal transmitted from a control unit to be described later, and moves the transportation belt 12. The driven roller 13 rotates along with movement of the transportation belt 12.

The print head unit 20 ejects inks with respect to the sheet of paper 1 on the transportation belt 12 at a timing synchronized with transportation movement (including a stationary state) to performs printing. Specifically, the print head unit 20 ejects inks from nozzles of a plurality of ejection units disposed on a head disposition surface 27 on a transportation unit 10 side in the print head unit 20. The printed-out sheet of paper 1 is fed to the paper discharging tray 6 on a downstream side by the transportation belt 12.

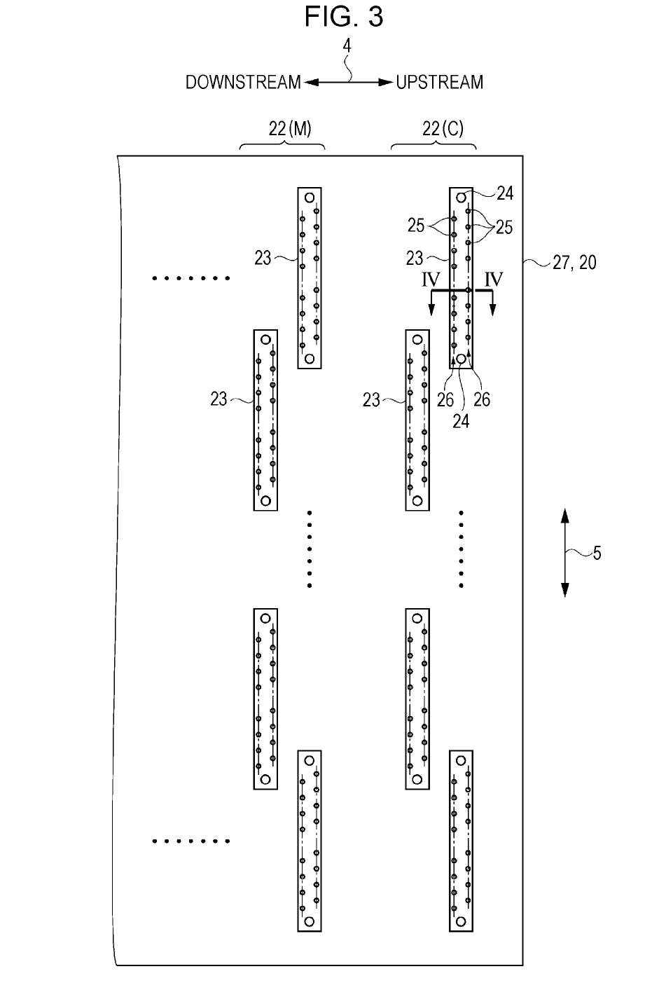

FIG. 3 is a plan view of the head disposition surface. Specifically, FIG. 3 is a plan view of the head disposition surface 27 when observing the print head unit 20 from a transportation unit 10 side.

As described above, a plurality of columns of line heads 22 corresponding to inks of a plurality of colors such as cyan, magenta, yellow, and black are formed in the print head unit 20. When being observed from the head disposition surface 27 side, a line head 22(C) for cyan, a line head 22(M) for magenta, a line head for yellow (not shown), a line head for black (not shown), . . . are disposed in this order from an upstream side to a downstream side in the transportation direction 4. A basic configuration of the line heads is common regardless of ink colors, and thus hereinafter, a description will be made by representatively referring to the line head 22(C) for cyan as the “line head 22”.

The line head 22 includes a plurality of print head module 23 that are disposed in a zigzag manner in the paper width direction 5.

Each of the print head modules 23 has an elongated rectangular shape, and is disposed in a state in which a long side direction is set as the paper width direction 5. In other words, two columns of print head modules 23, which are parallel with each other in the transportation direction 4, are disposed in the line head 22, and the print head modules 23 in each column are alternately disposed in the paper width direction 5. A reference hole 24 is respectively formed in both ends (short-side side) of the rectangular print head module 23.

In the head disposition surface 27, the print head module 23 is disposed with the the two reference holes 24 made as a planar position reference. The plurality of print head modules 23 are disposed in this manner, thereby constituting the line head 22 in which ejection units (ejection heads) are disposed at a constant pitch across the paper width direction 5. That is, an ejection unit column (nozzle column) across the paper width direction 5 which is constituted by the plurality of print head modules 23 instead of an independent constituent unit is referred to as the line head 22.

Each of the print head modules 23 is provided with two nozzle columns 26 each including a plurality of nozzles 25 disposed at a constant pitch in the paper width direction 5. The two nozzle columns 26 in the paper width direction 5 are disposed between the two reference holes 24. The two nozzle columns 26 are parallel with each other in the transportation direction 4, but are disposed to deviate (shift) by a half pitch in the paper width direction 5. In other words, the two nozzle columns 26 are disposed in a zigzag manner in such a manner that a nozzle 25 of an adjacent nozzle column is disposed at a half position of an arrangement pitch in the nozzle columns 26 in the transportation direction 4. This disposition is also referred to a zigzag disposition. According to this configuration, a printing dot density (resolution) in the paper width direction 5 increases. In addition, a nozzle length by the two nozzle columns 26 in the paper width direction 5 is also referred to as a “band length”. In the line head 22, the band length is continuously disposed in the paper width direction 5, thereby constituting the line head 22. In addition, although details will be described later, an ejection operation including an operation of a drive circuit is performed per unit of the print head module 23.

### Configuration of Ejection Unit

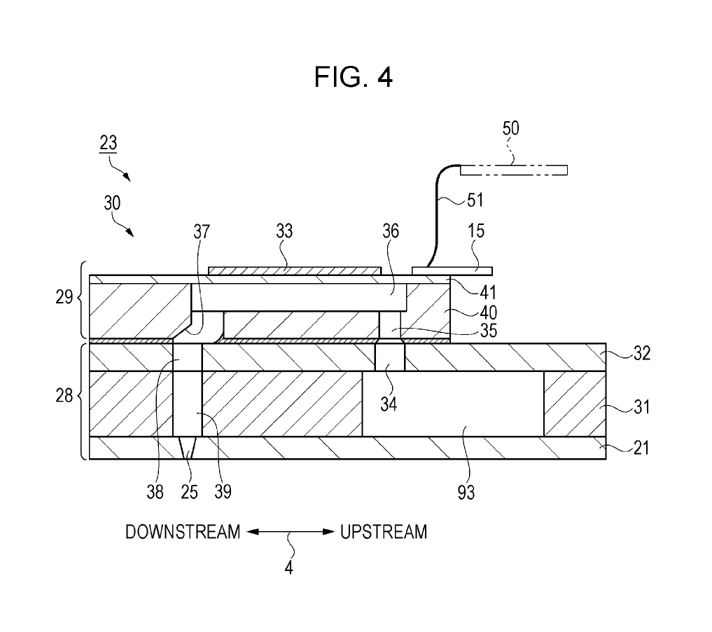

FIG. 4 is a cross-sectional view taken along IV-IV line in FIG. 3. Specifically, FIG. 4 is a side cross-sectional view of the nozzle columns 26 (ejection unit) in the transportation direction 4 of the print head modules 23.

Here, a single-component structure of the ejection units 30 that constitute the print head module 23, and an ink ejecting operation will be described.

Each of the ejection units 30 is an ink jet type recording head (ejection head) that ejects (sprays) an ink, and has a configuration in which a flow passage unit 28 and a drive unit 29 are stacked in this order from a nozzle plate 21 side.

The flow passage unit 28 includes the nozzle plate 21, a reservoir plate 31, a sealing plate 32, and the like.

In the nozzle plate 21, each ejection nozzle 25 of each of the ejection units is formed in a depth direction (paper width direction 5) of the drawing (paper surface).

The reservoir plate 31 is disposed on the nozzle plate 21 in an overlapping manner and includes a second communication hole 39 and a common ink chamber 93. The second communication hole 39 is a penetration hole that is formed at a position overlapping the nozzle 25. The common ink chamber 93 is a common ink chamber that is formed an upstream side in the transportation direction 4, and is also referred to as a reservoir. The common ink chamber 93 is formed across the ejection units that are continuous in the depth direction (the paper width direction 5) of the drawing. An ink is supplied to the common ink chamber 93 from an ink tank (not shown) through a supply passage (not shown) such as a tube.

The sealing plate 32 is a member that becomes a lid of the reservoir plate 31, and has a common supply port 34 and a first communication hole 38. The common supply port 34 is an ink supply port of the common ink chamber 93, and is formed in a slit shape along the common ink chamber 93 in the depth direction (the paper width direction 5) of the drawing. The first communication hole 38 is a penetration hole formed at a position overlapping the second communication hole 39.

The drive unit 29 includes a pressure chamber substrate 40, a vibrating plate 41, a head substrate 15, and the like. A pressure chamber 36 constituted by an elongated rectangular groove in the transportation direction 4 is formed in the pressure chamber substrate 40. The pressure chamber 36 is formed for each ejection unit, and thus in a plan view, a plurality of the pressure chambers 36 are formed in the pressure chamber substrate 40 in a comb tooth shape in the paper width direction 5. On an upstream side of the pressure chamber 36, a supply hole 35 constituted by a penetration hole is formed at a position overlapping the common supply port 34. On a downstream side of the pressure chamber 36, a communication hole 37 constituted by a penetration hole is formed at a position overlapping the first communication hole 38. In addition, the pressure chamber 36 is also referred to as a cavity.

The vibrating plate 41 is a member that becomes a lid of the pressure chamber substrate 40 (pressure chamber 36), and a piezoelectric element 33 as an actuator is attached onto a surface (top surface) that is opposite to the pressure chamber 36.

The head substrate 15 is disposed on an upper side of the drive unit 29, and selectively supplies a drive signal to the piezoelectric element 33. Although details will be described later, a switch selection circuit that sequentially and selectively supplies the drive signal with respect to the plurality of ejection units 30 (piezoelectric elements 33) is mounted on the head substrate 15. One sheet of the head substrate 15 is mounted with respect to the print head module 23 (FIG. 3). In other words, one sheet is set with respect to (over) the plurality of ejection units 30 that constitute the print head module 23. An FPC 51 is connected to the head substrate 15.

Continuously, an ink ejection operation will be described.

First, as an initial state of each of the above-described ejection units 30, the common ink chamber 93, the common supply port 34, the supply hole 35, the pressure chamber 36, the communication hole 37, the first communication hole 38, and the second communication hole 39 communicate with each other, and enter a state of being filled with an ink set to the same hydraulic pressure.

When a drive signal is applied to the piezoelectric element 33, the piezoelectric element 33 is contraction-vibrated. When the vibrating plate 41 is bent according to the contraction vibration and a volume of the pressure chamber 36 decreases, an ink is extruded and is ejected from the nozzle 25 as an ink droplet. In addition, when the volume of the pressure chamber 36 returns to an original state after the ink is ejected, a negative pressure is generated, and thus an ink corresponding to an amount of ejected ink is sucked into the pressure chamber 36 from the common ink chamber 93.

### Configuration of Control Circuit

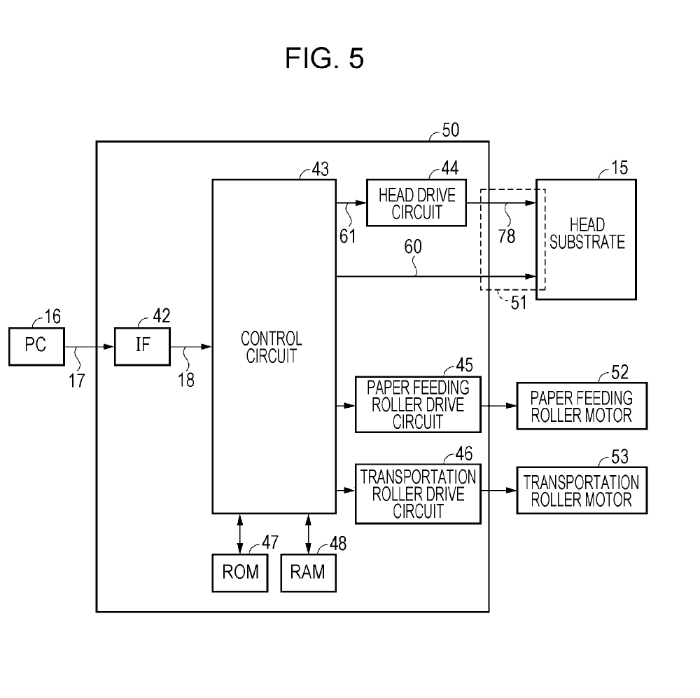

FIG. 5 is a block diagram illustrating a configuration of a control circuit of the printer.

Here, a configuration of the control device (circuit) that controls the printer 100 will be described. The control device of the printer 100 is constituted by a plurality of circuit units mounted on the main substrate 50 (FIG. 1). Accordingly, hereinafter, an overview of the control device will be described with reference to a circuit block configuration diagram of the main substrate 50 in FIG. 5.

On the main substrate 50 (control device), an interface circuit 42, a control circuit 43, a head drive circuit 44, a paper feeding roller drive circuit 45, a transportation roller drive circuit 46, and the like are mounted. The interface circuit 42 trims printing data 17 input from an external apparatus such as a personal computer (PC) to data capable of being processed in the control circuit 43, and transmits the trimmed data to the control circuit 43 as printing data 18.

The control circuit 43 is a central processing unit (CPU) and controls respective units such as the head drive circuit 44, the paper feeding roller drive circuit 45, and the transportation roller drive circuit 46. A read-only memory (ROM) 47, and a random access memory (RAM) 48 are annexed to the control circuit 43 as a storage unit. Various control programs that control an operation of the printer 100, data accompanying the various control programs, and the like are stored in the ROM 47. In addition, the accompanying data also includes a data table of drive signal data 61 that drives the piezoelectric element 33 (FIG. 4) of the ejection unit 30. A plurality of pieces of drive signal data in accordance with a resolution (dot size), a gradation, a color tone, and the like are stored in the table.

Printing data that is input, processing data that is necessary when printing the printing data, and the like are temporarily stored in the RAM 48. In addition, a program for a printing process and the like may be temporarily developed in some cases. In addition, there is no limitation to this configuration, and a one-chip dedicated system integrated circuit (IC) such as a micro controller unit (MCU) including a ROM and a RAM may be used.

In addition, the control circuit 43 distinguishes the printing data 18 input through the interface circuit 42 into printing data 60 and drive signal data 61 (generates the printing data 60 and the drive signal data 61), transmits the printing data 60 to the head substrate 15, and transmits the drive signal data 61 to the drive circuit 44. The printing data 60 is information about ON/OFF switching of the ejection unit 30 (FIG. 4) and control of an ejection timing in the print head. The drive signal data 61 is information about a voltage (drive signal) that is applied to the piezoelectric element 33 (FIG. 4) of the ejection unit 30.

The head drive circuit 44 will be described later. In addition, in FIG. 5, the drive circuit 44 that drives one of the print head modules 23 (FIG. 3) is illustrated for simplification. However, actually, the drive circuit 44 is mounted on the main substrate 50 in a number corresponding to the number of the print head modules 23 (head substrates 15).

The paper feeding roller drive circuit 45 is a drive circuit of a motor that rotates the paper feeding roller 7 (FIG. 2), and drives the paper feeding roller motor 52 based on a control signal transmitted from the control circuit 43.

The transportation roller drive circuit 46 is a drive circuit of a motor that rotates the transportation drive roller 11 (FIG. 2), and drives the transportation roller motor 53 based on a control signal transmitted from the control circuit 43.

### Configuration of Head Drive Circuit

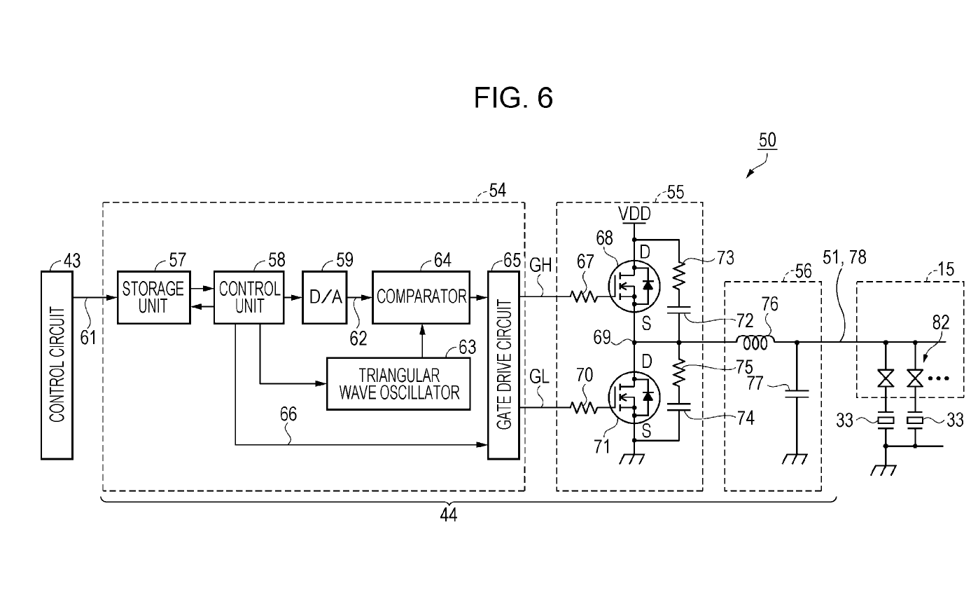

FIG. 6 is a block diagram illustrating a configuration of the head drive circuit.

Continuously, a circuit configuration of the drive circuit 44 will be described in detail.

The drive circuit 44 is a so-called D-grade amplifier (digital amplifier) that is constituted by a drive IC 54 a switching circuit 55, a filter circuit 56, and the like.

The drive IC 54 D/A converts the digital drive signal data 61 supplied from the control circuit 43 to generate original drive signal 62, performs pulse density modulation, and switches the switching circuit 55 based on the modulated data.

The drive IC 54 is constituted by a storage unit 57, a control unit 58, a D/A conversion unit 59, a triangular wave oscillator 63, a comparator 64, a gate drive circuit 65, and the like.

The storage unit 57 is a RAM and stores drive signal data 61 constituted by digital electric potential data and the like.

The control unit 58 converts drive signal data fetched from the storage unit 57 into a voltage signal, and holds the voltage data for a predetermined sampling period. In addition, the control unit 58 gives an instruction for a frequency of a triangular signal, a drive signal, a drive signal output timing, and the like to a triangular wave oscillator 63 to be described later. In addition, the control unit 58 also outputs an operation stopping signal 66 (on operation: high level) that stops an operation of the gate drive circuit 65.

The D/A conversion unit 59 converts the voltage signal output from the control unit 58 into an analog signal, and outputs the converted signal as the original drive signal 62. That is, the storage unit 57, the control unit 58, and the D/A conversion unit 59 function as an original drive signal generating circuit.

The triangular wave oscillator 63 outputs a triangular wave signal that becomes a reference signal in accordance with the frequency, the drive signal, and the drive signal output timing based on the instruction of the control unit 58.

The comparator 64 compares the original drive signal 62 output from the D/A conversion unit 59 and the triangular wave signal output from the triangular wave oscillator 63 with each other, and outputs a pulse-duty modulation signal (high frequency) that becomes an on-duty when the original drive signal 62 is larger than the triangular wave signal. As described above, the triangular wave oscillator 63 and the comparator 64 function as a modulation circuit (A/D converter).

The gate drive circuit 65 selectively turns on any of two transistors 68 and 71 of the switching circuit 55 to be described later based on the modulation signal transmitted from the comparator 64. In other words, the gate drive circuit 65 alternately switches (ON/OFF) the transistors 68 and 71 for switching. In addition, in a case where the operation stopping signal 66 transmitted from the control unit 58 is in a low level, the gate drive circuit 65 turns off all of the two transistors 68 and 71.

The switching circuit 55 is constituted by the two transistors 68 and 71, a capacitor 72, a resistor 73, a capacitor 74, a resistor 75, and the like. In addition, the gate drive circuit 65 and the switching circuit 55 function as a digital power amplification circuit.

The transistor 68 is a metal oxide semiconductor field effect transistor (MOSFET). In the transistor 68, a gate terminal is connected to a high-side output terminal GH of the gate drive circuit 65, a source terminal is connected to an intermediate node 69 (also, referred to as an intermediate electric potential 69) that becomes a half bridge output terminal, and a drain terminal is connected to a VDD. As an appropriate example, a resistor 67 is inserted (interposed) between the output terminal GH and the gate terminal.

The transistor 71 is a MOSFET. In the transistor 71, a gate terminal is connected to a low-side output terminal GL of the gate drive circuit 65, a source terminal is connected to a GND, and a drain terminal is connected to the intermediate node 69. As an appropriate example, a resistor 70 is inserted (interposed) between the output terminal GL and the gate terminal. In addition, the resistors 67 and 70 are overcurrent preventing resistors that prevent an overcurrent to the gate terminal.

In addition, as an appropriate example, the capacitor 72 and the resistor 73 are serially connected in this order between the source terminal and the drain terminal of the transistor 68. Similarly, the capacitor 74 and the resistor 75 are serially connected in this order between the source terminal and the drain terminal of the transistor 71. The capacitors and the resistors constitute a circuit that reduces a high frequency noise during switching. In addition, there is no limitation to this configuration, and a configuration by only the two transistors 68 and 71 is also possible.

An output signal of the switching circuit 55 is output from the intermediate node 69 to the filter circuit 56. The output signal is an amplified modulation signal obtained by amplifying a modulation signal, and becomes a high-frequency pulse signal in which pulses (rectangular waves) of a VDD electric potential (wave height) are continuous with the GND set as a reference.

The filter circuit 56 is a low-pass filter constituted by a coil 76, a capacitor 77, and the like.

One end of the coil 76 is connected to the intermediate node 69, and the other end is connected to one end of the capacitor 77. The other end of the capacitor 77 is connected to the GND. In addition, the other end of the coil 76 becomes an output line of a drive signal 78. Specifically, in an amplified modulation signal that is input to the filter circuit 56 from the switching circuit 55, a high-frequency region is cut out and is demodulated to an analog signal obtained by amplifying the original drive signal 62. The analog signal becomes the drive signal 78 and is supplied to the head substrate 15 through the FPC 51.

### Details of Drive Signal (Waveform)

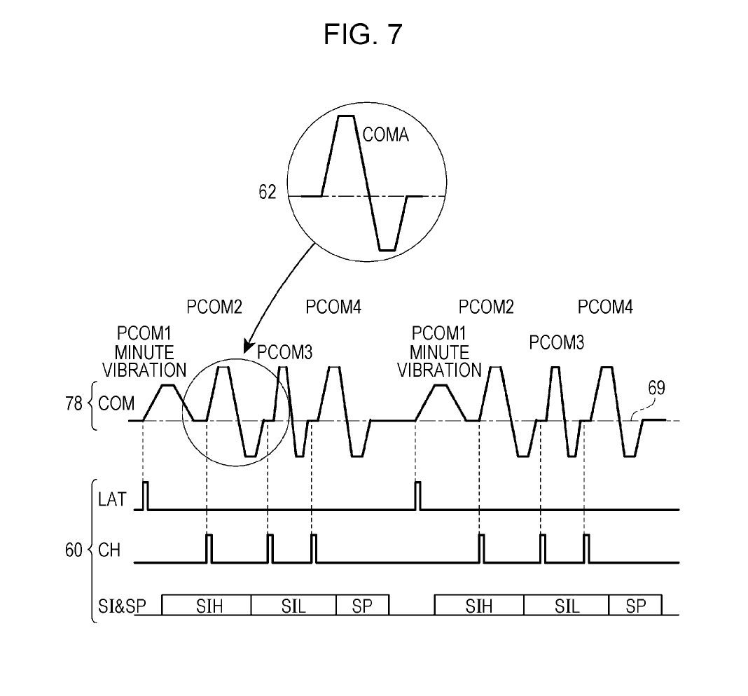

FIG. 7 is a view illustrating an example of a drive signal and printing data.

Here, a drive signal (waveform) that is generated by the drive circuit 44 will be described.

Similar to a waveform PCOM2, a representative drive signal 78 is a waveform which rises from the intermediate electric potential 69, retains a high electric potential (VDD) for a little while, falls under the intermediate electric potential 69, retains a low electric potential (GND) for a little while, rises again to the intermediate electric potential 69, and retains the intermediate electric potential 69 for a little while. In addition, similar to a waveform PCOM1, a waveform which rises from the intermediate electric potential 69, retains the high electric potential VDD for a little while, falls (returns) to the intermediate electric potential 69, and retains the intermediate electric potential 69 is also a drive waveform. That is, the drive signal 78 is constituted by the unit waveform PCOM1, PCOM2, PCOM3, . . . which are continuous in time series.

In the case of the waveform PCOM2, a rising portion is a step of expanding a volume of the pressure chamber 36 (FIG. 4) that communicates with the nozzle 25 (FIG. 4) to draw an ink (to pull in a meniscus in consideration of an ink ejection surface) into the pressure chamber 36, and the falling portion is a step of reducing the volume of the pressure chamber 36 to extrude the ink (to extrude the meniscus). According to this operation, an ink droplet is ejected from the nozzle. In addition, the waveform PCOM1 is a unit waveform that is called minute vibration, and is a waveform that allows an ink in the vicinity of the nozzle to fluctuate at a level in which the ink is not ejected (takes in and out the meniscus) to stir the ink, thereby suppressing thickening of the ink.

In addition, an ink droplet may be ejected by only a single waveform PCOM2. It is possible to change a pull-in amount of the ink, a pull-in speed of the ink, an ejected amount of the ink, or an ejection speed of the ink by changing a voltage increase and decrease inclination or a wave height value of the waveform PCOM2 constituted by a trapezoidal voltage waveform in various manners, thereby obtaining ink droplets having sizes different from each other.

As is the case with the drive signal 78 in FIG. 7, when a plurality of drive waveforms are connected in time series, it is possible to impact next ink droplet to the same position before previously impacted ink is dried, and thus it is also possible to make a printing dot size large. Also, it is possible to realize multi-gradation in combination with this technology.

Continuously, a waveform quality of the drive signal 78 and the like will be described with reference to FIG. 6.

As described above, the drive signal 78 is a signal obtained by amplifying the original drive signal 62 generated by the D/A conversion unit 59. Specifically, the drive signal 78 is a signal obtained by amplifying the original drive signal 62 in which a vibration range (peak to peak) is several volts (for example, approximately 3 V) to a signal having a vibration range of several tens volts (for example, approximately 42 V). For example, the waveform PCOM2 is a waveform obtained by amplifying a waveform COMA (an enlarged view on an upper side of FIG. 7) in the original drive signal 62.

Here, with regard to a waveform quality (degree of similarity before and after amplification) of the drive signal 78, the waveform of the original drive signal 62 is reproduced in an approximately reliable manner by suppressing jaggies.

The reason of the approximately reliable reproduction is that a pulse density modulation method is employed. Specific reasons are as follows. For example, a power supply voltage is set to 42 V, it is necessary for a vibration range of the drive signal 78 to be as wide as approximately 2 V to 37 V. To perform pulse modulation while securing a waveform quality, operation with a high-frequency modulation signal in the order of MHz is necessary. However, according to experiment results obtained by the present inventors, the pulse density modulation method is more appropriate for high-frequency operation in comparison to a pulse width modulation method in which a period is constant. In addition, in a typical audio apparatus, a frequency of approximately 32 kHz to 400 kHz is used. In addition, there is no limitation to the pulse density modulation method, and a modulation method compatible with a high-frequency operation on the order of MHz is also possible.

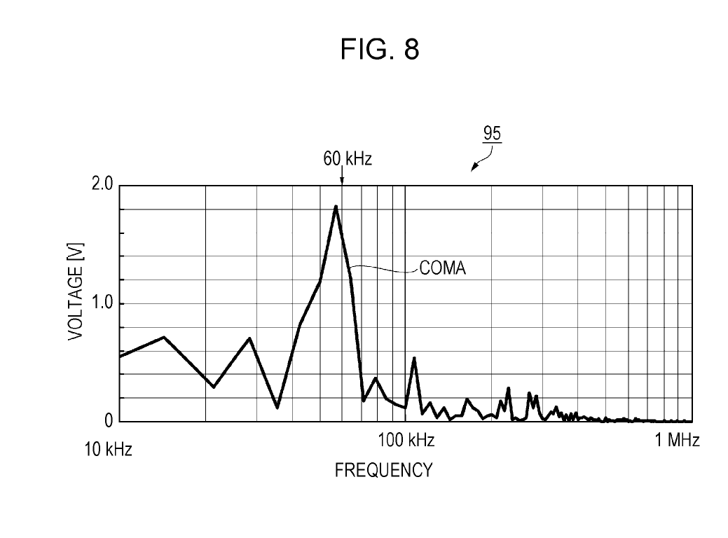

FIG. 8 is a spectrum analysis diagram of an original drive signal. Specifically, FIG. 8 is a view obtained by performing frequency spectrum analysis with respect to the waveform COMA (waveform PCOM2 after amplification) in the original drive signal in FIG. 7. As shown in a graph 95, it can be seen that a frequency of approximately 10 kHz to 400 kHz is included in the original drive signal COMA that is subjected to the frequency spectrum analysis.

To amplify a drive signal by a digital amplifier, it is necessary to drive the digital amplifier with a switching frequency at least 10 or more times that of a frequency component included in the drive signal before amplification. If the switching frequency of the digital amplifier is less than 10 times in comparison to a frequency spectrum included in the drive signal, it is difficult to perform amplification by modulating a high-frequency spectrum component included in the drive signal, and thus a corner (edge) of the drive signal becomes dull and is rounded. When the drive signal becomes dull, movement of the piezoelectric element that operates along with a rising edge and a falling edge of a waveform gradually occurs, and thus an ejected amount may be unstable, or ejection may not occur. That is, there is a concern that an unstable operation may occur.

In this embodiment, as shown in a graph 95 in FIG. 8, a peak is present at approximately 60 kHz, and many components are less than 100 kHz, an thus it is preferable that the digital amplifier be operable at a switching frequency of approximately 1 MHz that is at least 10 times the 100 kHz.

Here, a frequency component included in the original drive signal is different depending on a waveform of the original drive signal in accordance with the size of an ink droplet to be ejected or the size of a printing dot. For example, the waveform COMA is an original drive signal for ejecting an ink droplet having a size smaller than a standard size, and thus as shown in FIG. 8, a vibration range is made to be as small as approximately 2 V. As described above, to eject a small-sized ink droplet, it is necessary to allow the piezoelectric element to sharply move so as to eject a small amount of ink droplet. Therefore, it is necessary for the drive signal to include many high-frequency spectrum components. In addition, it is necessary to quickly move the piezoelectric element so as to perform high-speed printing, and thus it is necessary for the drive signal to include many high-frequency spectrum components. That is, the further high-speed and high image quality printing is tried, the higher a demanded minimum frequency becomes.

In addition, the drive signal in this embodiment is designed for use in typical homes and offices, and thus the drive signal is designed on the assumption that a A4-size printed material having a resolution of approximately 5760×1440 dpi is obtained at a printing speed of 5 sheets per minute by using 180 piezoelectric elements.

In addition, even in a case where the switching frequency is high, a different problem occurs. When performing switching with a high voltage and a high frequency for driving the piezoelectric element, a junction capacity increases due to a switching transistor structure, and thus various problems such as occurrence of noise caused by the increase in the junction capacity, and an increase in a switching loss due to the high-frequency operation are apt to occur. Particularly, the increase in the switching loss may be a significant problem in the digital amplifier. The reason of the significance is that the increase in the switching loss may damage a merit relating to power saving properties and low heat-generation properties of the digital amplifier which are superior to that of an AB-grade amplifier (analog amplifier).

In this embodiment, when being compared with the analog amplifier (AB-grade amplifier) that has been used in the related art, it can be seen that the following results are obtained. That is, the digital amplifier is superior to the analog amplifier up to 8 MHz, but in a case of driving the transistor at a frequency higher than 8 MHz, the AB-grade amplifier may be superior to the digital amplifier.

In consideration of these situations, it is preferable that the frequency of the modulation signal be equal to or higher than 1 MHz and lower than 8 MHz. In this embodiment, the frequency of the modulation signal may be set to a range of equal or higher than 1 MHz and lower than 8 MHz in accordance with specifications of the ejection unit (piezoelectric element), or an ejection quality.

### Method of Selecting (Switching) Ejection Unit

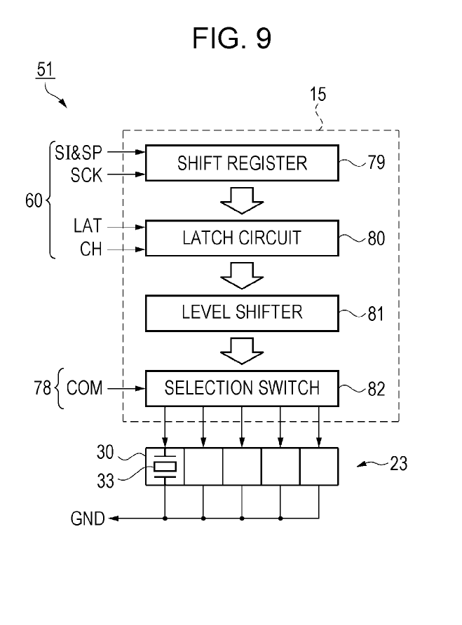

FIG. 9 is a circuit block diagram of the head substrate.

Continuously, a circuit configuration of the head substrate 15, and a switching method of sequentially selecting the plurality of ejection units 30 (piezoelectric elements 33) of the print head module 23 (FIG. 3) will be described.

In FIG. 7, an example of the printing data 60 is shown on a lower side of the drive signal 78. The printing data 60 is a signal for performing ON/OFF switching of the ejection units and control of an ejection timing in the print head, and examples thereof include a drive pulse selection signal SI&SP, a latch signal LAT, a channel signal CH, a clock signal (not shown), and the like.

As shown in FIG. 9, as is case with the drive signal 78, the printing data 60 is supplied to the head substrate 15 through the FPC 51.

The head substrate 15 is constituted by a shift register 79, a latch circuit 80, a level shifter 81, a selection switch 82, and the like.

The drive pulse selection signal SI&SP is sequentially input to the shift register 79, and a storage region thereof is sequentially shifted from an initial stage to a subsequent stage in accordance with an input pulse of the clock signal (not shown). After the drive pulse selection signal SI&SP is stored in the shift register 79 in a number corresponding to the number of nozzles, the latch circuit 80 latches each output signal of the shift register in response to the latch signal LAT that is input. A signal retained in the latch circuit 80 is converted by the level shifter 81 into a signal having a voltage level capable of turning ON/OFF a subsequent-stage selection switch 82. The reason of the voltage conversion is that the drive signal 78 is set to a voltage higher than an output voltage of the latch circuit 80, and thus an operation voltage of the selection switch 82 is also set to be high in accordance with the level. In addition, the channel signal CH is also input to the latch circuit 80. The channel signal CH latches an individual waveform PCOM of the drive signal 78. That is, serial drive signals 78 start to be output with the latch signal LAT, and an individual waveform PCOM is output for each channel signal CH.

In this manner, the drive signal 78 is supplied to the piezoelectric element 33 of an ejection unit, in which a corresponding individual switch is turned on, at a connection timing of the drive pulse selection signal SI&SP.

In addition, after the drive pulse selection signal SI&SP of the shift register 79 is retained in the latch circuit 80, subsequent printing information is input to the shift register 79, and retention data of the latch circuit is sequentially updated in accordance with the ejection timing of an ink droplet.

### Interconnection Aspect of Drive Circuit in Main Substrate

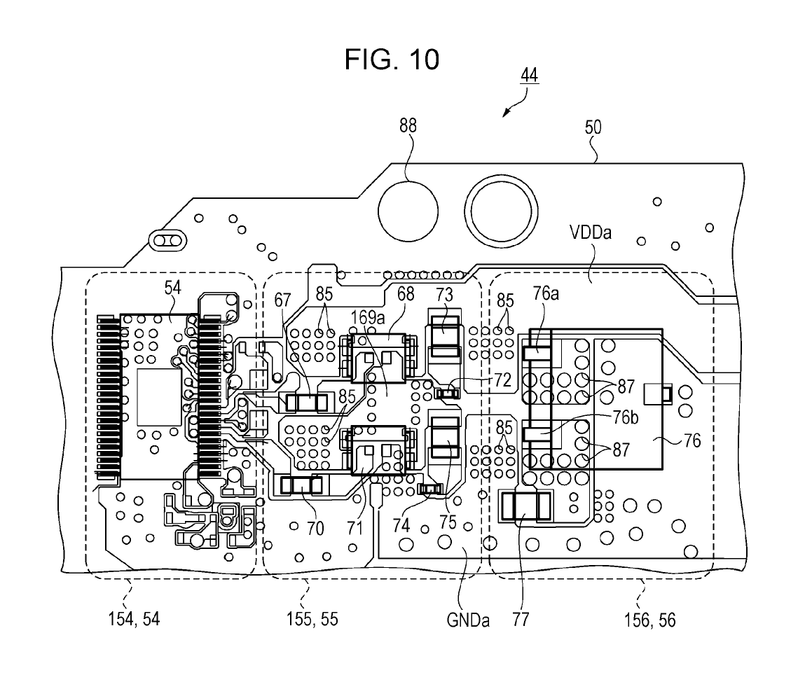

FIG. 10 is a plan view of a drive circuit region in the main substrate.

First, basic specifications of the main substrate 50 will be described.

In this embodiment, as an appropriate example of the main substrate 50, a double-sided substrate that is a glass epoxy substrate (for example, FR4) is employed. In an initial state, copper foil is bonded to the entirety of a front surface and a rear surface, and the copper foil is patterned by a known method such as an etching method or a photolithography method to form a necessary interconnection pattern.

Here, a plurality of through-holes 85 (hereinafter, also referred to as THs 85), which penetrate between the front surface and the rear surface and establish electrical connection between interconnections on the front surface and interconnections on the rear surface, are formed in the main substrate 50. In addition, in this embodiment, “through-hole” is a via in Japanese Industrial Standard Printed Circuit terminology (JIS C5603-1993), and is a hole that is used for interlayer connection. Each of the THs 85 is formed by boring a hole in the substrate and plating an inner wall of the hole.

FIG. 10 illustrates a mounting region in which the drive circuit 44 is mounted (disposed) on the front surface (first surface) of the main substrate 50. The drive circuit is mounted across three regions in which a drive IC mounting region 154, a switching circuit mounting region 155, and a filter circuit mounting region 156 are continuous. In addition, in this embodiment, the main substrate 50 is also referred to as a drive substrate.

The drive IC 54 is mounted in the drive IC mounting region 154. The switching circuit mounting region 155 is disposed on a right side of the drive IC mounting region 154 on the paper (drawing).

The resistors 67 and 70, the transistors 68 and 71, the capacitor 72, the resistor 73, the capacitor 74, and the resistor 75 are mounted in the switching circuit mounting region 155. The filter circuit mounting region 156 is disposed on a right side of the switching circuit mounting region 155.

The coil 76 and the capacitor 77 are mounted in the filter circuit mounting region 156. In this manner, all components that constitute the drive circuit 44 are mounted on the surface, but many THs 85 are disposed at a region centering around the switching circuit mounting region 155, and the THs 85 are used for electrical connections of these components.

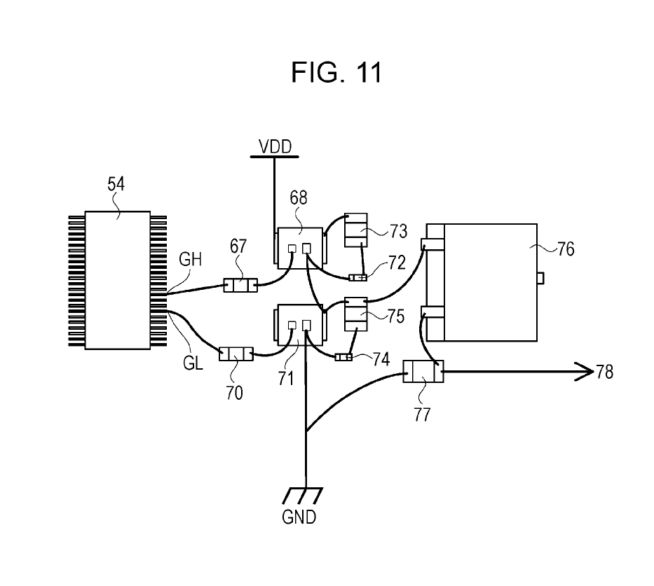

FIG. 11 is a plan view illustrating an interconnection scale of the drive circuit and corresponds to FIG. 10.

FIG. 11 is a view obtained by extracting the components of the drive circuit 44 from FIG. 10, and by connecting terminals of respective components with solid lines similar to circuit interconnections in FIG. 6. As can be seen from the drawing, a portion in which solid lines intersect each other is not present, and the interconnections are completed on a single surface (front surface). That is, it can be seen that the drive circuit 44 has an interconnection scale that can be mounted on a single-sided substrate without providing the TH 85.

On the other hand, as described above, an expensive double-sided substrate is used as the actual main substrate 50, and many THs 85 are formed in the main substrate 50. The reason of this configuration is that the THs 85 are used for heat dissipation. According to experiment results obtained by the present inventors, it is can be seen that when the THs 85 are formed in a heat generation portion, a heat dissipation effect is obtained. Details will be described below.

### Heat Generation Distribution

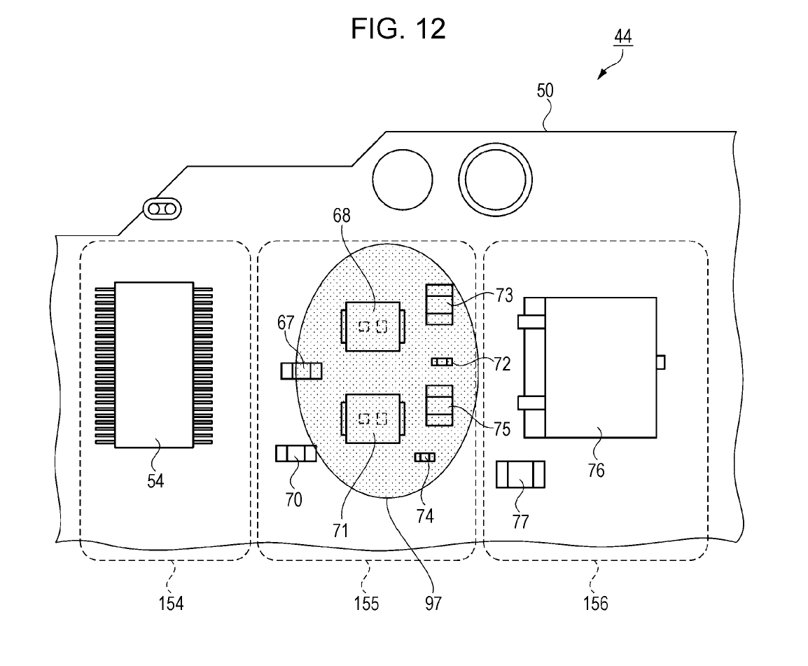

FIG. 12 is a plan view illustrating a heat generation distribution of the drive circuit and corresponds to FIG. 10.

To examine a heat generation distribution of the drive circuit 44, the present inventors mounted the drive circuit 44 on a glass epoxy substrate for evaluation, and a temperature distribution was examined with a thermography in a state in which a load was applied to the drive circuit 44 under substantially the same test conditions as that in actual operation. In addition, an interconnection pattern of the substrate for evaluation was made to be different from that of the actual main substrate 50 (FIG. 10) and was set to have simple specifications in which through-holes for heat dissipation were not provided, and electrical interconnections and interconnections necessary for evaluation were formed.

FIG. 12 illustrates results of the above-described test. A portion in which a temperature was the highest was the switching circuit mounting region 155. In the switching circuit mounting region 155, a heat generation region 97 indicated by a shadow ellipse centering around the two transistors 68 and 71 was at a high temperature. Specifically, a temperature of the package of the transistors 68 and 71 was the highest and the temperature was approximately 70° C., and a temperature of patterns at the periphery of a drain terminal of each of the transistors was 65° C. to 70° C. Even in a region in which the temperature was the highest among other regions, the temperature was lower than 50° C. With regard to ranking, the filter circuit mounting region 156 ranked second and the drive IC mounting region 154 ranked third (the temperature was the lowest among the three regions).

With regard to determination whether or not the heat generation of approximately the highest temperature of 70° C. obtained from the experiment results is a temperature level that becomes a problem, a configuration including only one drive circuit 44 may not cause a problem. However, actually, a plurality of the drive circuits 44 are mounted on the main substrate 50 adjacently to each other as described above. Therefore, the present inventors made the following determination. Although a heat sink is not necessary, an arbitrary countermeasure for heat dissipation is necessary in consideration of the following situations and the like. That is, the main substrate 50 is mounted on a bottom side in a casing 3 (FIG. 1) and thus heat is likely to be shut, and in addition to heat generation in the plurality of drive circuits 44 adjacent to each other, heat from other heat generation sources such as a power supply circuit is applied to the main substrate 50.

With regard to a situation in which the two transistors 68 and 71 themselves become the biggest heat generation portion, a main cause of the situation is considered due to a switching loss. Specifically, power at on-resistance inside a transistor is consumed as heat due to a current flowing between a drain and a source during switching. Particularly, the switching loss occurs for each switching, and thus in the drive circuit 44 that operates with a high-frequency in the order of MHz that is 10 or more times that of an audio apparatus and the like, a considerable amount of heat generation occurs.

### Simulation of Through-Hole for Heat Dissipation

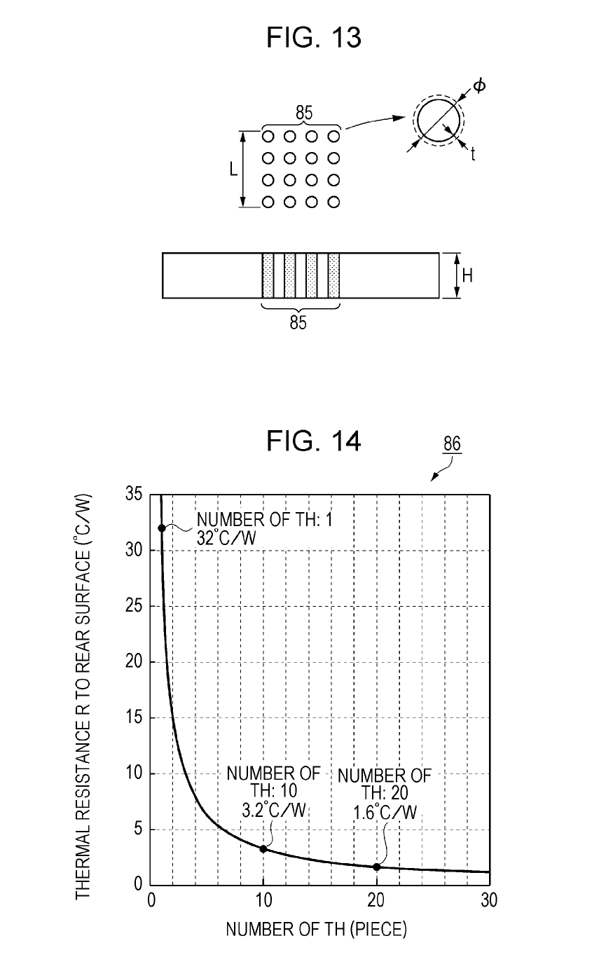

FIG. 13 is a view illustrating a substrate setting in a simulation. FIG. 14 is a graph illustrating heat dissipation characteristics with respect to the rear surface of the substrate.

When finding various countermeasures for heat dissipation on the basis of the above-described heat generation distribution results, the present inventors thought up provision of the through-holes for heat dissipation in the substrate, and performed a simulation with respect to a heat dissipation effect in the through-holes. In the simulation, conditions of a simulation substrate are set as shown in FIG. 13.

In the simulation substrate in FIG. 13, the THs 85 are disposed in a manner of 4(row)×4(column) (totally, sixteen). A length in the disposition region is set as “L”. In addition, in the simulation, to change the number of the THs 85, the length L is also changed in accordance with the number of THs 85. At this time, an arrangement pitch of the THs 85 is set to be constant.

In addition, the number of the THs 85 is set as “N”, a diameter of (hole diameter) is set as φ, and the thickness of plating is set as “t”. In addition, the thickness of the substrate is set as “H”.

A thermal conductivity of copper that constitutes interconnections and plating is set as “Ka”, and a thermal conductivity of a resin in the glass epoxy substrate is set as “Kb”.

The following theoretical formulae are derived based on the above-described setting conditions.

First, a thermal resistance Ra of a through-hole portion is obtained by the following Expression (1).

$$Ra = \frac{H}{Ka \times N \times π \times φ \times t} \qquad ( 1 )$$

Similarly, a thermal resistance Rb of a resin portion in the substrate is obtained by the following Expression (2).

$$Rb = \frac{H}{Kb \times ( {L}^{2} - N \times π \times φ \times t )} \qquad ( 2 )$$

In addition, a thermal resistance R from the front surface to the rear surface of the substrate is obtained by the following Expression (3).

$$R = \frac{1}{\frac{1}{Ra} + \frac{1}{Rb}} \qquad ( 3 )$$

A graph 86 in FIG. 14 is a result obtained by simulating a variation in the thermal resistance R from the front surface to the rear surface of the substrate by using Expression (1) to Expression (3) in a case of changing the number of THs 85. The horizontal axis represents the number of through-holes, and the vertical axis represents the thermal resistance R. In addition, in the simulation, the diameter (hole diameter) φ of the THs 85 is set to 0.75 mm, and the thickness t of the plating is set to 35 μm. The arrangement pitch of the THs 85 is set to 1.4 mm. Accordingly, in FIG. 13, the length L of the arrangement region in which four THs 85 are arranged in a row is approximately 5 mm (4.95 mm), but as described above, the length L varies in accordance with the number of the THs 85. In addition, the thickness H of the substrate is set to 1 mm. The simulation is performed in a state in which the thermal conductivity Ka of copper is set to 380 W/mK and the thermal conductivity Kb of the resin in the glass epoxy substrate is set to 0.3 W/mK.

As can be seen from the graph 86, in a case where only one TH 85 is provided, the thermal resistance R becomes 32° C./W, and thus a heat dissipation effect is hardly expected. However, in a case where the number of the THs 85 is set to 10, the thermal resistance R becomes 3.2 ° C./W that is 1/10 times that of the case in which one TH 85 is provided, and thus a considerable heat dissipation capacity can be obtained. In addition, from the simulation, it can be seen that as the number of the THs 85 increases, the thermal resistance decreases. In addition, the graph 86 is obtained by performing calculation using the above-described simulation conditions (the size of the TH 85 and the like), but there is no limitation to the conditions. Even when the size of the TH 85, the arrangement pitch, and the like vary, the characteristic (tendency) of the graph in that as the number of THs 85 increases, the thermal resistance decreases is maintained. In other words, when the size of the THs 85, the arrangement pitch, and the like vary, the inclination (variation) of the graph is changed. However, the fact in that the heat dissipation effect increases by increasing the number of THs 85 is also true of this case.

The reason that the through-holes show a heat dissipation operation is considered due to thermal conduction provided by the copper plating (metal) formed mainly on the inner wall of the TH 85. Specifically, heat of the front surface pattern migrates (conducts) to the rear surface pattern through the copper plating of the TH 85. In addition, although not considered in the simulation, in a case of forming a hollow (penetration) through-hole such as a large-sized through-hole in which the inside is empty, a heat dissipation effect due to convection of the air may be further expected.

### Detailed Arrangement Aspect of Through-Hole

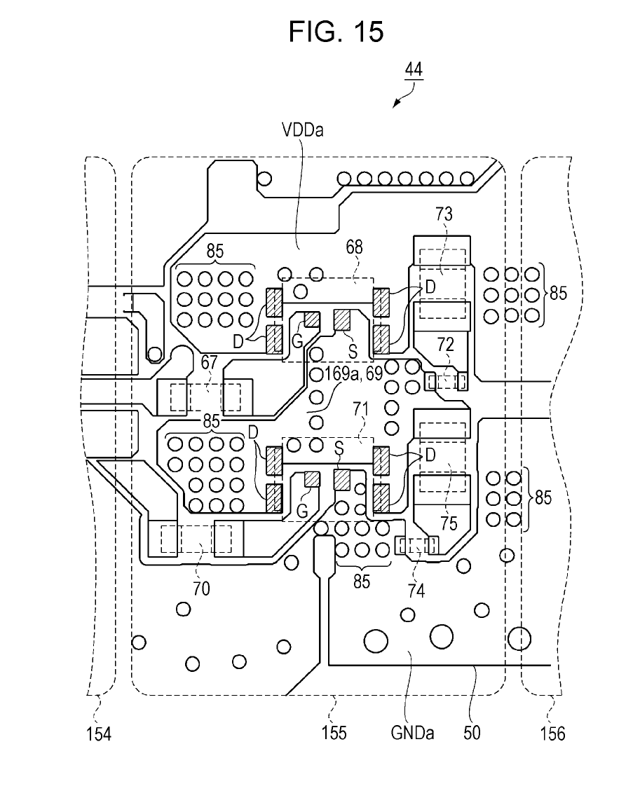

FIG. 15 is an enlarged view of the switching circuit mounting region in FIG. 10. In addition, a scale of the entirety of the drawing is enlarged, but a relative scale between components and a pattern size (including the TH) maintains a ratio of design values. This is also true of in respective drawings subsequent to FIG. 10. In addition, the following description will be made on the assumption that in the drawing, a drive IC mounting region 154 side is set as a left side, a filter circuit mounting region 156 side set as a right side, and a right and left direction is set as a horizontal direction with the switching circuit mounting region 155 made as the center. Similarly, the following description will be made on the assumption that a transistor 71 side is set a lower upper side, a side opposite to the transistor 71 side is set as an upper side, and an upper and lower direction is set as a vertical direction with the transistor 68 set as the center. In addition, in FIG. 15, the external shape (package) of electronic components is indicated by a dotted line for easy visibility of interconnections (pattern).

An interconnection layout (pattern, TH arrangement) of the drive circuit 44 is designed based on findings obtained from the above-described examination about heat generation distribution and the above-described simulation about the through-holes for heat dissipation.

Here, an interconnection layout at the periphery of mounting terminals of transistors will be described. First, a description will be made starting from an interconnection (first interconnection) that is connected to the drain terminal of the transistor 68. The drain terminal ranks second to transistor package as a portion in which an amount of heat generation is large.

As shown in FIG. 15, a drain terminal D of the transistor 68 is disposed along two short sides of horizontally elongated rectangular package. The drain terminal D is respectively disposed at the right side and the left side in a division manner. However, the drain terminals D are the same electrical terminals, and thus a solid pattern that expands to an upper side of the package connects to the right and left drain terminals D in a state of surrounding three sides of the package. In addition, for example, a typical interconnection pattern is linear member (interconnection line) having a width of approximately 0.5 mm, and electrical connection is sufficiently performed with this width. However, in this embodiment, a region (solid pattern) broader than an electrically necessary line width is provided as a through-hole forming (arranging) region to obtain a heat dissipation function from the front surface. In addition, an interconnection that is directly connected to each terminal of transistors is referred to as the first interconnection. The solid pattern is a high electric potential VDD (FIG. 6) interconnection in a power supply electric potential. In addition, in the following description, the solid pattern (region) is also referred to as solid pattern VDDa.

Here, in the solid pattern VDDa, eighteen THs 85 are formed even in the switching circuit mounting region 155. Specifically, fifteen THs 85 are formed in the vicinity of a left drain terminal D, and three THs 85 are formed in a portion ranging through the resistor 73 from the right drain terminal D. In addition, the three THs 85 on a resistor 73 side are parts of a group of the THs 85 which are also continuous to the filter circuit mounting region 156 side, and thus when adding the number (6 pieces) of the THs in the group, a total number of the THs becomes 24. That is, a large number of THs 85 are formed in comparison to the number of terminals (totally four; the gate G, the source S, and the drain D×2) necessary for mounting of the transistor 68. In addition, in the drawing, mounting terminals for the gate terminal G, the source terminal S, and the drain terminal D of the transistor 68 are hatched, and this hatching illustrates a recommended land (pattern) size in component specifications. A land size of the drain terminal D is 1.3 mm (vertical)×1.0 mm (horizontal). In addition, as shown in the drawing, a recommended land of the drain terminal D is vertically divided into two pieces, but a drain terminal on a package side is one (integrated), and thus the number of necessary terminals is set to four. Even assuming that the portions divided into two are counted, the number of the terminals is six, and thus the number of the THs 85 is larger than the number of terminals. In addition, as an appropriate example, the diameter φ of the TH 85 is set to 0.75 mm, and the thickness t of the plating is set to 35 μm. A basic arrangement pitch of the TH 85 is set to 1.4 mm.

In addition, an area of the solid pattern VDDa as the first interconnection is set to be broader (larger) than the land size of the drain terminal D. This is also obvious when considering that lands of all of the drain terminals D are included in the region of the solid pattern VDDa. In addition, in an actual substrate, an insulating resist layer is formed on approximately the entire surface of the solid pattern VDDa, and the resist is opened in an amount corresponding to the mounting terminals including the land of the drain terminal D, and thus a copper pattern is exposed. That is, the resist is arranged across a region other than the mounting terminal (land) portions indicated by hatching in the drawing. In addition, in FIG. 15, hatching of mounting terminals in components other than the transistor is omitted, but this arrangement is also true of components other than the transistor. In addition, an area of the solid pattern VDDa is set to be broader than the package size (plane area) of the transistor 68. Even in the switching circuit mounting region 155, the area of the solid pattern VDDa is approximately two times the area of the package.

Next, an interconnection (first interconnection) that is connected to the source terminal S of the transistor 68 will be described. The source terminal S is formed on a bottom surface (bottom portion) of the package. A land size of the source terminal S is set to 1.0 mm (vertical)×0.7 mm (horizontal). The first interconnection that is led-out from the source terminal S has a solid pattern shape broader than the land size from the starting point, and is largely expanded toward a transistor 71 side to form a solid pattern 169a including the drain terminal D of the transistor 71. In other words, the solid pattern 169a is an intermediate node 69 (FIG. 6) interconnection, and electrically connects between the source terminal S of the transistor 68, and the drain terminal D of the transistor 71.

Here, twenty six THs 85 are formed in the solid pattern 169a. Specifically, six THs 85 are formed between the transistor 68 and the transistor 71, six THs 85 are formed on a lower-right side of the transistor 68, and fourteen THs 85 are formed on a left side of a package of the transistor 71. That is, a large number of THs 85 are formed in comparison to the number of terminals necessary for mounting of the transistor 68.

In addition, an area of the solid pattern 169a as the first interconnection is set to be broader (larger) that the land size of the source terminal S (drain terminal D). This is also obvious when considering that the land of the source terminal S (drain terminals D) is included in the region of the solid pattern 169b. In addition, an area of the solid pattern 169a is set to be broader than a package size (plane area) of the transistor 68. Specifically, the area of the solid pattern 169a is approximately two times the area of the package.

Next, an interconnection (first interconnection) that is connected to the gate terminal G of the transistor 68 will be described. In addition, as described above, the gate terminal is not a heat generation source. However, the gate terminal is a terminal of the transistor 68, and thus the gate terminal is collectively described. The gate terminal G is also formed on the bottom surface (bottom portion) of the package. A land size of the gate terminal G is set to 0.7 mm (vertical)×0.7 mm (horizontal). The first interconnection that is led-out from the gate terminal G has a solid pattern shape broader than the land size from the starting point, is largely expanded toward a lower-left side, and is connected to the other end of the resistor 67.

Continuously, the transistor 71 will be described. In addition, the transistor 71 is the same component as the transistor 68, and thus a description of a terminal position, a land size, and the like will not be repeated.

An interconnection that is connected to the drain terminal D of the transistor 71 is the same as the solid pattern 169a of the source terminal S of the transistor 68. As described above, twenty six THs 85 are formed in the solid pattern 169a, and the majority of the THs 85 are disposed in the vicinity of the drain terminal D of the transistor 71.

A first interconnection that is led-out from the source terminal S of the transistor 71 has a solid pattern shape broader than the land size from the starting point, and is largely expanded toward a lower side. The first interconnection is divided into a right region and a left region in the middle of the expansion toward the lower side, but the first interconnection respectively forms further broader solid pattern GNDa on the right region and the left region. The solid pattern GNDa is low electric potential GND (FIG. 6) interconnection in the power supply electric potential. Even in the switching circuit mounting region 155, twenty two THs 85 are formed in the solid pattern GNDa. Specifically, eleven THs 85 are formed on a lower side immediately close to the source terminal S, six THs 85 are formed on the region that is divided as a lower-right region, and five THs 85 are formed on the region that is divided as a lower-left region. That is, a large number of THs 85 are formed in comparison to the number of terminals necessary for mounting of the transistor 71. In addition, the solid pattern GNDa is also a power supply electric potential, and thus the solid pattern GNDa is further expanded toward left and right sides. Therefore, when the TH is formed in the further expanded portions, the number of the THs further increases.

In addition, an area of the solid pattern GNDa as the first interconnection is set to be broader (larger) that the land size of the source terminal S. This is also obvious when considering that the land of the source terminal S is included in the region of the solid pattern GNDa. In addition, an area of the solid pattern GNDa is set to be broader than a package size (plane area) of the transistor 71. Specifically, the area of the solid pattern GNDa9 is approximately five or more times the area of the package even in the switching circuit mounting region 155.

Next, an interconnection (first interconnection) that is connected to the gate terminal G of the transistor will be described. The first interconnection that is led-out from the gate terminal G has a solid pattern shape broader than the land size from the starting point, is largely expanded toward lower-left side, and is connected to the other end of the resistor 70. The interconnection is substantially the same interconnection aspect as the gate terminal G of the transistor 68.

Continuously, an interconnection aspect of components at the periphery of the transistors 68 and 71 will be described.

The capacitor 72 and the resistor 73, which are connected between the source terminal S and the drain terminal D of the transistor 68, are disposed in a state of being surrounded by the solid pattern 169a and the solid pattern VDDa. That is, the capacitor 72 and the resistor 73 are disposed in a state of being surrounded by a plurality of the THs 85 that are formed in the solid pattern 169a and the solid pattern VDDa.

Similarly, the capacitor 74 and the resistor 75, which are connected between the source terminal S and the drain terminal D of the transistor 71 are also disposed in a state of being surrounded by the solid pattern GNDa and the solid pattern 169a. That is, the capacitor 74 and the resistor 75 are disposed in a state of being surrounded by a plurality of THs 85 that are formed in the solid pattern GNDa and the solid pattern 169a.

### Interconnection Aspect of Filter Circuit

A description will be made with reference to FIG. 10.

Continuously, an interconnection aspect of the filter circuit mounting region 156 that ranks second to the switching circuit mounting region 155 in the amount of heat generation will be described.

The coil 76 has an approximately square package, and input terminal 76a and an output terminal 76b are provided on a left side (left-hand side). In addition, a mounting terminal is provided on a right side (right-hand side). A package size is larger than the area of two transistors 68.

The input terminal 76a that is located on an upper side of the left-hand side is electrically connected to the solid pattern 169a through a plurality of THs 87. Each of the THs 87 is a through-hole having a diameter larger than that of the TH 85, and the inside is empty (air can pass through the inside). As an appropriate example, the diameter φ of the TH 87 is set to 1.5 mm, and the thickness t of plating is set to 35 μm. An arrangement pitch of the TH 87 is set to 2.0 mm.

A mounting land of the input terminal 76a is included in a corner of an approximately square solid pattern in which the TH 87 is formed. In other words, the corner of the approximately square solid pattern becomes the mounting land. In addition, ten THs 87 are formed in the solid pattern.

A plurality of THs 87 are formed in the vicinity of the output terminal 76b. A mounting land of the output terminal 76b is included in a corner of the approximately rectangular solid pattern in which the TH 87 is formed. A mounting land for one end of the capacitor 77 is formed on a lower side of the solid pattern. In the solid pattern, in addition to the ten THs 87, two THs 85 are formed in the vicinity of the capacitor 77.

A mounting land for other end of the capacitor 77 is formed in the solid pattern GNDa. Ten or more THs 85 are also formed at a portion close to the mounting land for the other end of the capacitor 77.

### Interconnection Aspect of Substrate Rear Surface

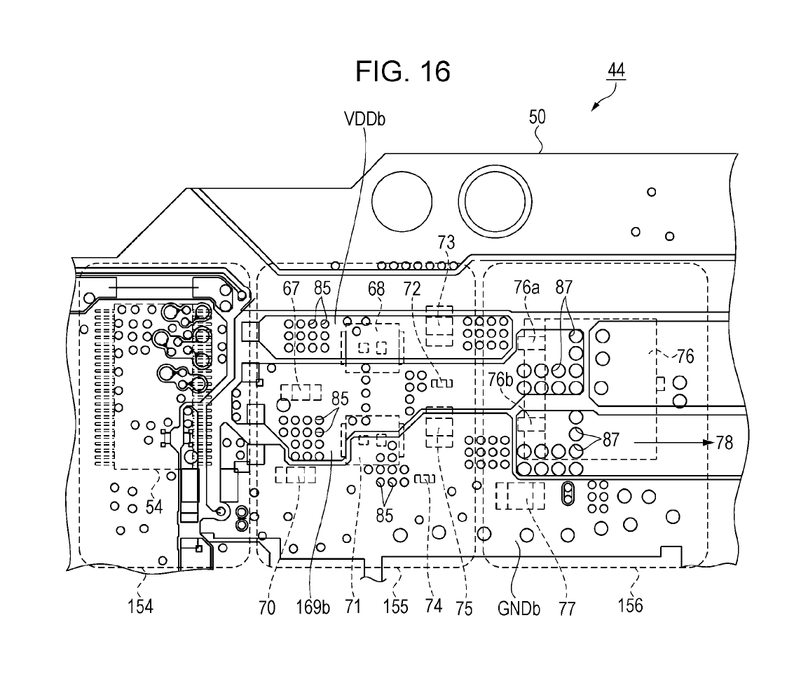

FIG. 16 is an enlarged plan view of a mounting region in which the drive circuit 44 is mounted on a rear surface (second surface) of the main substrate 50, and FIG. 16 corresponds to FIG. 10. In addition, for easy comprehension of a relationship with component arrangement on the front surface, FIG. 16 is drawn as a perspective view in which an interconnection on the rear surface is drawn in a perspective manner from a front surface side. An external shape of components is indicated by a dotted line.

Components are not mounted in the mounting region of the drive circuit 44 on the rear surface as the second surface, and the mounting region is formed as an approximately flat surface. First, a description will be made starting from a solid pattern 169b as a second interconnection that is formed between the two transistors and 71 in a horizontally elongated shape. The solid pattern 169b is an interconnection (second interconnection) that is electrically connected to the solid pattern 169a (FIGS. 10 and 15) on the front surface through the plurality of THs 85. The solid pattern 169b is disposed in a horizontally elongated manner from the vicinity of the drive IC 54 to an intermediate portion of the coil 76. At a portion overlapping the coil 76, connection is established with the mounting land of the input terminal 76a of the coil 76 by the plurality of THs 87.

Here, an area of the solid pattern 169b is set to be broader than the package (external) size of the transistor 68 (71). Specifically, the solid pattern 169b has an area approximately six to seven times that of the package.

On an upper side of the solid pattern 169b, a solid pattern VDDb as the second interconnection is formed. The solid pattern VDDb is an interconnection (second interconnection) that is connected to the solid pattern VDDa (FIG. 10) on the front surface through the plurality of THs 85. The solid pattern VDDb is disposed in a horizontally elongated shape from the vicinity of the drive IC 54 to a region ranging to a part of the filter circuit mounting region 156. An area of the solid pattern VDDb is set to be broader than the package size of the transistor 68. Specifically, the solid pattern VDDb has an area approximately three times that of the package.

On a lower side of the solid pattern 169b, a solid pattern GNDb as a second interconnection is formed. The solid pattern GNDb is an interconnection (second interconnection) that is connected to the solid pattern GNDa (FIG. 10) on the front surface through the plurality of THs 85. The solid pattern GNDb is disposed in a horizontally elongated shape across a wide range from the vicinity of the drive IC 54 to a region exceeding the filter circuit mounting region 156. An area of the solid pattern GNDb is set to be broader than the package size of the transistor 68. Specifically, the solid pattern GNDb has an area approximately ten times that of the package.

### Heat Dissipation Structure to Frame

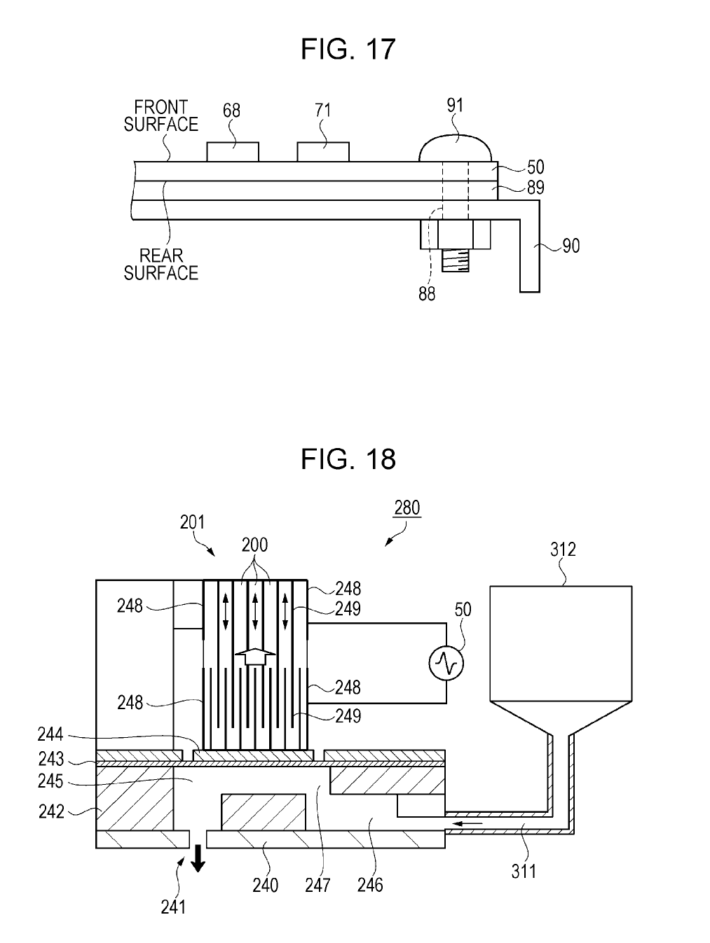

FIG. 17 is a cross-sectional view illustrating an aspect of a heat dissipation structure to a frame.

As also illustrated in FIG. 1, the main substrate 50 is mounted on the frame of the printer 100. The frame is a metal frame, and is formed by subjecting a metal plate to press working or thin plate working.

As shown in FIG. 17, the main substrate 50 is mounted on the frame 90 in a state in which the rear surface (second surface) faces the frame 90. The main substrate 50 is attached to a metal plate surface portion that is flat in a structure of the frame 90. The main substrate 50 is tightly fixed to frame 90 by fastening a screw 91 through a screw hole 88 (FIG. 10). In addition, the screw fastening is performed at a plurality of sites at a peripheral portion of the main substrate 50.

Here, a heat transfer member 89 is disposed (interposed) between the main substrate 50 and the frame 90. The heat transfer member 89 is sheet-shaped member having flexibility, heat transfer properties, and insulating properties. In an appropriate example, a heat dissipation sheet formed from a silicone rubber to which a ceramic-based material having excellent thermal conductivity is mixed is used as the heat transfer member 89. In addition, there is no limitation to this member, and an arbitrary sheet-shaped member having the flexibility, the heat transfer properties, and the insulating properties may be used.

In an approximate example, the heat transfer member is disposed across the entire surface of the main substrate 50. In addition, there is no limitation to this configuration, and the heat transfer member 89 may be disposed across a region including a portion overlapping the mounting region of the drive circuit 44.

As described above, according to the printer 100 according to this embodiment, the following effects can be obtained.

As a countermeasure for heat generation accompanying the high-frequency operation, the present inventors repeated the examination and simulation about the heat generation distribution of the drive circuit 44, and repeated trial and error. Then, the present inventions thought up a configuration in which a double-sided substrate is used in spite of an interconnection scale capable of being interconnected with a single-sided substrate, and through-holes for heat dissipation are formed in a transistor arranging region. According to this, it is possible to stabilize the operation of the drive circuit 44 that performs high-frequency operation without using a large-sized (expensive) heat dissipation component such as a heat sink. In other words, it is possible to improve reliability of the drive circuit 44. Specifically, in the heat generation distribution examination in FIG. 12, a temperature of the package of the transistors is the highest and the temperature is approximately 70° C. However, according to the interconnection aspect (including arrangement of the through-holes) of the main substrate 50, the temperature becomes approximately 60° C., and thus it is possible to accomplish a temperature falling (heat dissipation effect) by approximately 10° C. Similarly, it is also realize temperature falling by approximately 10° C. in patterns at the periphery of the drain terminal.

Accordingly, it is possible to provide the main substrate 50 (drive substrate) which has a simple configuration and in which operation stability is realized (secured) even though including the drive circuit 44 that performs high-frequency operation without using a dedicated heat dissipation component such as a heat sink. In other words, it is possible to provide the main substrate 50 (drive substrate) which has a small size and which is excellent in reliability.

Accordingly, it is possible to provide the printer 100 which has a simple configuration and which realizes operation stability without using a dedicated heat dissipation component.

As a specific through-hole arrangement aspect, the TH 85 is formed in a region of the main substrate 50 in which the switching transistors 68 and 71 are disposed. That is, the TH 85 is formed in a main heat generation region. As illustrated in FIG. 10, it is not necessary to provide a through-hole in consideration of an interconnection scale of the drive circuit 44, but the TH 85 is formed for heat dissipation. In other words, a large number of THs 85 are formed in comparison to the number of through-holes that are necessary for interconnection of the drive circuit 44 in the substrate. According to this configuration, it is possible to improve heat dissipation performance of the drive circuit 44. The reason of employing this configuration is as follows. Specifically, as illustrated in FIG. 14, as the number of the THs 85 for heat dissipation increases, the heat dissipation effect can be raised.

As the number of THs 85 increases, the higher heat dissipation effect can be expected. However, generally, as the number of the THs 85 increases, man-hours taken to manufacture the substrate increase and the cost increases, and there is a restriction on a forming space. Therefore, a constant index is necessary. According to experiment results obtained by the present inventors, the number of the mounting terminals of a switching transistor becomes one index, and it can be seen that when forming a large number of through-holes than the number of the mounting terminals, a constant heat dissipation effect is obtained. With regard to a through-hole forming site, it is preferable that the through-hole be formed in an interconnection that is connected to each terminal of the transistors 68 and 71, but the through-hole may be formed in a region at the periphery of the transistor. In the case of the transistors 68 and 71 that is used in this embodiment, the number of mounting terminals is four (six including divided portions). However, in a case of using three-terminal type, three becomes an index. More preferably, as illustrated in FIG. 14, 10 or more through-holes are formed. In this embodiment, in the switching circuit mounting region 155, eighteen THs 85 are provided in the solid pattern VDDa, twenty six THs 85 are provided in the solid pattern 169a, and twenty two THs 85 are provided in the solid pattern GNDa. In this manner, the above-described index is satisfied only with the solid pattern VDDa in the switching circuit mounting region 155, and thus it is possible to obtain a sufficient heat dissipation effect.

In addition, in an interconnection design of a typical substrate, an interconnection that is led-out from a land of a component is typically formed from a conductive line (pattern) that is narrower than the land. The reason is that a narrow pattern is sufficient to satisfy electrical connection specifications. On the other hand, in this embodiment, the lead-out line from the gate terminal G of the transistor, in which the amount of heat generation is relatively small, is also formed from a solid pattern broader than a land size (0.7 mm) from the starting point. With regard to the source terminal S and the drain terminal D, a further broader solid pattern is used. The reason is that the solid pattern is used for not only electrical interconnection but also heat dissipation. Specifically, the solid patterns come into contact with the air, and thus as the area increases, it is possible to expect heat dissipation due to the air. As the solid pattern is broader, the heat dissipation effect can be expected. However, there is a restriction on a forming space. Therefore, a constant index is necessary. As illustrated in FIG. 12, a portion in which the amount of heat generation is the largest is the package of the transistors 68 and 71, but when a heat sink is mounted to the package, the number of components increases, and an increase in a size is caused. Accordingly, in this embodiment, the periphery of the transistor is formed as a solid pattern, and thus an alternate function of the heat sink is realized. Accordingly, the package size (plane area) of the transistors is set as an index.

In this embodiment, the solid pattern VDDa is set to have an area approximately two times that of the package of the transistors. The solid pattern VDDb is set to have an area approximately three times that of the package. Similarly, the solid pattern 169a is set to have an area approximately two time that of the package. The solid pattern 169b is set to have an area approximately six to seven times that of the package. In addition, the solid pattern GNDa is set to have an area approximately five times the package. The solid pattern VDDb is set to have an area approximately ten or more times that of the package. In this manner, all of the solid patterns on the front and rear surfaces satisfy the above-described index, and thus a sufficient heat dissipation effect can be obtained. Specifically, the periphery of the transistors 68 and 71 is surrounded by the solid patterns, and thus the entirety of the mounting region is allowed to function as a heat dissipation plate. In addition, solid patterns broader than that on the front surface are also formed on the rear surface to which heat is transferred through a plurality of through-holes, and thus the rear surface is also allowed to function as a heat dissipation plate.

In addition, the method of forming (designing) the through-holes for heat dissipation and the solid patterns is also applied to interconnection patterns of resistors 73 and 75 and the capacitors 72 and 74 which are components at the periphery of the transistors. In addition, the method is also applied to the filter circuit 56 and the interconnection pattern of the drive IC 54. That is, the method is applied to the entirety of the mounting region of the drive circuit 44, and thus a sufficient heat dissipation function is provided. Particularly, the TH 87 in which the inside is empty and which has a large diameter is formed at the periphery of the input terminal 76a and the output terminal 76b of the coil 76 of the filter circuit 56. According to the TH 87, the air can pass through the inside, and thus an air flow occurs between the front and rear surfaces, thereby further increasing the heat dissipation effect.

In addition, as illustrated in FIG. 17, the main substrate 50 is mounted on the frame 90 in a state in which the rear surface faces the frame 90, and the heat transfer member 89 is disposed (interposed) between the main substrate 50 and the frame 90. According to this configuration, it is possible to reliably dissipate heat of the main substrate 50 to the frame 90. The frame 90 has a large heat capacity, and an area exposed to the air of the outside is also broad, and thus the frame 90 can sufficiently function as the heat dissipation plate.

In addition, generally, it is said that man-hours increase in the double-sided substrate having the through-holes due to an increase in man-hours taken for through-hole punching or man-hours taken for plating in comparison to a single-sided substrate. In addition, in addition to the increase in the man-hours, a raw material is also more expensive than that of the single-sided substrate, and thus it is said that the cost increases (two times or four times). This embodiment employs a configuration in which the drive circuit 44 is mounted on the main substrate 50 on which the control circuit 43 is mounted without constituting the drive circuit 44 as an independent substrate, and thus the cost is suppressed. Specifically, the main substrate 50 including the CPU uses a double-sided substrate in consideration of an interconnection scale, and the drive circuit 44 is mounted by increasing an area of the substrate. Accordingly, a great reduction effect is obtained in consideration of the number of components and main-hours in comparison to a case of separately providing an independent substrate.

In addition, the invention is no limited to the above-described embodiment, and various changes and modification can be made with respect to the above-described embodiment. Modification Examples will be described below.

### MODIFICATION EXAMPLE 1

A description will be made with reference to FIG. 13.

In Embodiment 1, the description has been made with respect to a configuration in which the glass epoxy substrate is used as the main substrate 50. However, there is no limitation to this configuration, and an arbitrary substrate is also possible as long as the through-holes can be formed in the substrate. For example, a ceramic substrate, a Teflon (registered trade mark) substrate, a glass composite substrate, a paper epoxy substrate, a flexible substrate, and the like may be used.

In addition, there is no limitation to the double-sided substrate, and the invention may be applied to a multi-layer substrate. In this case, it is not necessary for the through-holes to penetrate the substrate from a front surface to a rear surface, and for example, connection may be established from through-holes in the front surface to through-hole in the rear surface through an intermediate layer (solid) pattern. In other words, there is no problem as long as a heat transfer route from the front surface to the rear surface is formed.

In addition, there is no limitation to a through-hole (plated through-hole) in which an plated interconnection is formed on an inner wall, and an arbitrary through-hole is possible as long as the through-hole can transfer heat from the front surface to the rear surface. For example, a through-hole filled with conductive paste is possible, and a through-hole in which solder plating is formed on an inner wall is also possible. In addition, there is no limitation to the size or the arrangement pitch of the through-holes described in an appropriate example of the embodiment. The size or arrangement pitch of the through-holes may be appropriately changed in accordance with a substrate that is used, and design specifications such as a circuit scale and a substrate mounting type to a casing, a frame, and the like.

Even in this configuration, the above-described heat dissipation operation effect is also obtained, and thus the same effect as the above-described embodiment can be obtained.

### MODIFICATION EXAMPLE 2

A description will be made with reference to FIG. 16.

In Embodiment 1 and Modification Example 1, the description has been made with respect to a configuration in which the drive circuit 44 is mounted on the main substrate 50. However, there is no limitation to this configuration, and a single configuration (substrate) is possible as long as a double-sided through-hole substrate is used. For example, it is possible to employ a configuration in which an independent drive substrate (on which the drive circuit 44 is mounted) is built-in in the print head unit 20 in FIG. 1. In this configuration, the drive substrate is mounted on a metal component of the print head unit 20. In addition, it is also possible to employ a configuration in which a circuit of the head substrate 15 is also mounted on the drive substrate and thus the head substrate 15 and the substrate are integrated is built-in in the print head unit 20.

Even in this configuration, the above-described heat dissipation operation effect is also obtained, and thus the same effect as the above-described embodiment and modification examples can be obtained.

### MODIFICATION EXAMPLE 3

A description will be made with reference to FIG. 1.

In the embodiment and modification examples, the printer 100 has been described as a line printer that performs printing with a single pass in the transportation direction 4 (sub-scanning direction). However, there is no limitation to this configuration, and an arbitrary printer is possible as long as this printer is provided with the print head module 23. For example, a so-called carriage type ink jet printer provided with a carriage that performs printing while reciprocally moving in the paper width direction 5 (main scanning direction) is also possible. In this case, an ink cartridge and the print head module 23 are mounted on the carriage. An extension direction of the nozzle column (band length) in the print head module 23 becomes the transportation direction 4, and feeding of the sheet of paper 1 is performed per band length unit. In addition, with regard to a printing medium, there is no limitation to a single sheet (sheet of paper), and a rolled sheet of paper or a continuous sheet of paper is possible. In addition, a material of the printing medium is not limited to the sheet of paper, and texture or a film is possible.

Even in this configuration, the above-described heat dissipation operation effect is also obtained, and thus the same effect as the above-described embodiment and modification examples can be obtained.

### MODIFICATION EXAMPLE 4

FIG. 18 is a schematic configuration view of an ejection unit with a different vibration mode.

In the above-described embodiment and modification examples, the description has been made with respect to a type in which the vibration mode of the piezoelectric element 33 of the ejection unit 30 (FIG. 4) uses a bending mode. However, there is no limitation to this configuration, and any ejection unit is possible as long as this ejection unit uses vibration of the piezoelectric element. For example, similar to an ejection unit 280 in FIG. 18, a head using a vertical mode is also possible. Specifically, in the ejection unit 280, an ink inside a pressure chamber 245 is ejected from a nozzle 241 due to operation of a piezoelectric element 200. The ejection unit 280 includes a nozzle plate 240 in which the nozzle 241 is formed, a cavity plate 242, a vibrating plate 243, and a stacked piezoelectric element 201 constituted by stacking a plurality of the piezoelectric elements 200.

The cavity plate 242 is shaped into a predetermined shape (shape in which a concave portion is formed), and thus the pressure chamber 245 and a reservoir 246 are formed. The pressure chamber 245 and the reservoir 246 communicate with each other through an ink supply port 247. In addition, the reservoir 246 communicates with an ink cartridge 312 through an ink supply tube 311.

A lower end of the stacked piezoelectric element 201 is bonded to the vibrating plate 243 through an intermediate layer 244. A plurality of outer electrodes 248 and a plurality of inner electrodes 249 are bonded to the stacked piezoelectric element 201. That is, the outer electrodes 248 are bonded to the outer surface of the stacked piezoelectric element 201, and each of the inner electrodes 249 is respectively provided between the piezoelectric elements 200 that constitute the stacked piezoelectric element 201 (or, at the inside of each of the piezoelectric elements). In this case, the outer electrodes 248 and the inner electrodes 249 are arranged in such a manner that a part of each of the outer electrodes 248 and a part of each of the inner electrodes 249 alternately overlap each other in a thickness direction of the piezoelectric element 200. In addition, when a drive signal is applied between the outer electrode 248 and the inner electrode 249 from the drive circuit 44 (head substrate 15), the stacked piezoelectric element 201 is deformed as indicated by an arrow in the drawing and vibrates, and the vibrating plate 243 vibrates due to the vibration. Due to the vibration of the vibrating plate 243, the volume of the pressure chamber 245 (pressure inside the pressure chamber) varies, and thus an ink (liquid) that is filled in the pressure chamber 245 is ejected from the nozzle 241 as a liquid droplet. Due to the ejection of the liquid droplet, an amount of liquid that is reduced in the pressure chamber 245 is refilled by supply of the ink from the reservoir 246. In addition, the ink is supplied to the reservoir 246 from the ink cartridge 312 through the ink supply tube 311.

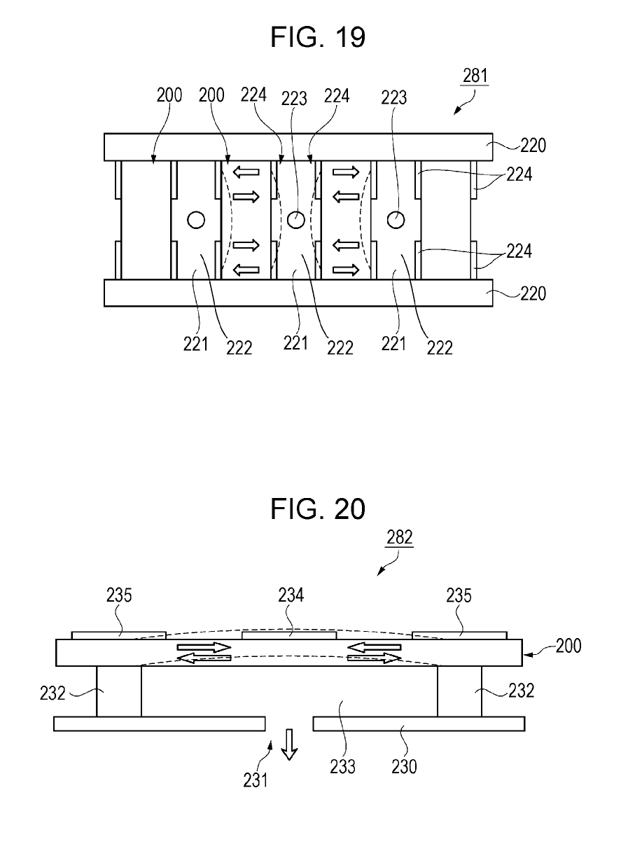

FIG. 19 is a schematic configuration view of an ejection unit with a different vibration mode. FIG. 20 is a schematic configuration view of an ejection unit with a different vibration mode.

In addition, there is no limitation to the configuration (FIGS. 4 and 18) in which the piezoelectric element is attached to the vibrating plate, and a configuration in which the piezoelectric element also functions as the vibrating plate is also possible. In other words, a configuration in which a dedicated vibrating plate is not provided is also possible.

In addition, an ejection unit 281 in FIG. 19 also has a configuration that an ink (liquid) inside a pressure chamber 221 is ejected from a nozzle due to operation of a piezoelectric element 200. The ejection unit 281 includes a pair of opposing substrates 220, and a plurality of the piezoelectric elements 200 are intermittently provided between both of the substrates 220 with a predetermined interval. A pressure chamber 221 is formed between the piezoelectric elements 200 adjacent to each other. In the drawing, a plate (not shown) is provided in front of the pressure chamber 221, the nozzle plate 222 is formed behind the pressure chamber 221, and a nozzle (hole) 223 is formed in the nozzle plate 222 at a position corresponding to each of the pressure chamber 221.

A pair of electrodes 224 is respectively provided on one surface and the other surface of each of the piezoelectric elements 200. That is, four electrodes 224 are bonded to one of the piezoelectric elements 200. When a predetermined drive voltage waveform is applied between predetermined electrodes among the electrodes 224, the piezoelectric element 200 is subjected to share mode deformation and vibrates (indicated by an arrow in the drawing). Due to the vibration, the volume (pressure in a cavity) of the pressure chamber 221 varies, and thus an ink (liquid) that is filled in the pressure chamber 221 is ejected from the nozzle 223 as a liquid droplet. That is, in the ejection unit 281, the piezoelectric element 200 itself functions as a vibrating plate.

An ejection unit 282 illustrated in FIG. 20 also has a configuration that an ink (liquid) inside a pressure chamber 233 is ejected from a nozzle 231 due to operation of a piezoelectric element 200. The ejection unit 282 includes a nozzle plate 230 in which the nozzle 231 is formed, a spacer 232, and a piezoelectric element 200. The piezoelectric element 200 is provided to be spaced away from the nozzle plate 230 by a predetermined distance through a spacer 232, and a pressure chamber 233 is formed in a space surround by the nozzle plate 230, the piezoelectric element 200, and the spacer 232.

A plurality of electrodes are bonded to an upper surface of the piezoelectric element 200 in the drawing. Specifically, a first electrode 234 is bonded to approximately the central portion of the piezoelectric element 200, and a second electrode 235 is respectively bonded to both side portions of the central portion. When a predetermined drive voltage waveform is applied between the first electrode 234 and the second electrode 235, the piezoelectric element 200 is subjected to share mode deformation and vibrates (indicated by an arrow in the drawing). Due to the vibration, the volume (pressure in a cavity) of the pressure chamber 233 varies, and thus an ink (liquid) that is filled in the pressure chamber 233 is ejected from the nozzle 231 as a liquid droplet. That is, in the ejection unit 282, the piezoelectric element 200 itself functions as a vibrating plate.

In addition, hereinbefore, the description has been made by using the piezoelectric element as an actuator. However, there is no limitation to this configuration, and the invention may be applied to various actuators. For example, the actuator may be a so-called electrostatic actuator which includes a first electrode bonded to an outer side (vibrating plate) of a pressure chamber and a second electrode that is spaced away from the first electrode and faces the first electrode, and a drive voltage is applied to both of the electrodes to generate Coulomb's force, thereby bending the pressure chamber.

In addition, as the actuator, an actuator using electro-thermal conversion by a heater (resistor) is also known. However, when using electromotive conversion by a piezoelectric element, power consumption per one actuator is large. Accordingly, with regard to use of the drive circuit 44 using a digital amplifier, the drive circuit 44 is particularly effective for a piezo-type liquid ejecting apparatus in which consumption of much power is necessary.

### MODIFICATION EXAMPLE 5

A description will be made with reference to FIG. 1.

In the above-described embodiment and modification examples, the main substrate 50 (drive substrate) is used for ejection of a printing ink. However, there is no limitation to the use, and the main substrate 50 may be applied to a liquid spraying apparatus that sprays other liquids (including fluidal substance such as a liquid substance and gel in which a functional material particles are dispersed in addition to the liquids) other than the ink, or a fluid (a solid capable of being sprayed as a fluid, and the like) other than a liquid. For example, the main substrate 50 may be used in a liquid substance spraying apparatus that sprays liquid substance containing materials such as an electrode material and a coloring material, which are used for manufacturing of a liquid crystal display, an electroluminescence (EL) display, a surface light-emitting display, a color filer, and the like, in a dispersion manner or a dissolution manner, a liquid spraying apparatus that sprays living body organic materials that are used for manufacturing of biochips, and a liquid spraying apparatus that sprays a liquid that is used as a precision pipette and becomes a sample. In addition, the main substrate 50 may be applied to a liquid spraying apparatus that sprays a lubricant to a precision machine such as a timepiece and a camera as a pinpoint, a liquid spraying apparatus that sprays a transparent resin liquid such as a ultraviolet curable resin, which is used to form a micro hemispheric lens (optical lens) that is used in an optical communication element and the like, to a substrate, a liquid spraying apparatus that sprays an etchant such as an acid and an alkali to etch a substrate and the like, a fluidal substance spraying apparatus that sprays a gel, and a fluid spraying type recording device that sprays a solid such as a powder including a toner.

Even in a case of being applied to these apparatuses, the above-described heat dissipation operation effect is also obtained, and thus the same effect as the above-described embodiment and modification examples can be obtained.

What is claimed is:

1. A liquid ejecting apparatus, comprising:
an A/D converter that performs pulse modulation of an original drive signal at a high frequency region to generate a modulation signal;
a transistor that amplifies the modulation signal to generate an amplified modulation signal;
a filter circuit that smooths the amplified modulation signal to generate a drive signal;
an ejection unit that is subjected to an ejection operation by the drive signal to eject liquid droplets; and
a substrate on which at least the transistor is disposed,
wherein through-holes are formed in the substrate in a region in which the transistor is disposed.

2. The liquid ejecting apparatus according to claim 1,
wherein a frequency band of an AC component included in the modulation signal or the amplified modulation signal is 1 MHz or higher.

3. The liquid ejecting apparatus according to claim 1,
wherein a frequency band of an AC component included in the modulation signal or the amplified modulation signal is lower than 8 MHz.

4. The liquid ejecting apparatus according to claim 1,
wherein a number of the through-holes is more than a number of mounting terminals that mount the transistor on the substrate.

5. The liquid ejecting apparatus according to claim 1,
wherein a number of the through-holes is more than a number of through-holes that are necessary to interconnect the transistor and the filter circuit to the substrate.

6. The liquid ejecting apparatus according to claim 1,
wherein a number of the through-holes is 10 or more.

7. The liquid ejecting apparatus according to claim 4,
wherein the through-holes are formed in a first interconnection that extends from each of the mounting terminals in the transistor.

8. The liquid ejecting apparatus according to claim 7,
wherein a solid pattern region, which is broader than the mounting terminal, is formed in the first interconnection, and the through-holes are formed in the solid pattern region.

9. The liquid ejecting apparatus according to claim 8,
wherein an area of the solid pattern region is broader than a plane area of the transistor.

10. The liquid ejecting apparatus according to claim 4,
wherein the substrate is a double-sided substrate,
the transistor and the filter circuit are mounted on a first surface of the substrate, and
a second interconnection, which is connected to the first interconnection through the through-holes, is formed on a second surface that is opposite to the first surface.

11. The liquid ejecting apparatus according to claim 10,
wherein an area of the second interconnection is broader than a plane area of the transistor.

12. The liquid ejecting apparatus according to claim 10, further comprising:
a casing body; and
a frame of the casing body,
wherein the substrate is mounted on the frame in a state in which the second surface faces the frame, and
a heat conductive member is interposed between the frame and the substrate.

13. The liquid ejecting apparatus according to claim 1,
wherein the ejection unit includes,
a piezoelectric element,
a pressure chamber which is filled with a liquid and in which an inner pressure increases or decreases due to displacement of the piezoelectric element, and
a nozzle which communicates with the pressure chamber and ejects the liquid as the liquid droplets due to the increase and decrease in the pressure inside the pressure chamber.

14. A drive substrate, comprising:
an A/D converter that performs pulse modulation of an original drive signal at a high frequency region to generate a modulation signal;
a transistor that amplifies the modulation signal to generate an amplified modulation signal;
a filter circuit that smooths the amplified modulation signal to generate a drive signal; and
a substrate on which at least the transistor is disposed,
wherein through-holes are formed in the substrate in a region in which the transistor is disposed.

15. A printer head unit, comprising:
an A/D converter that performs pulse modulation of an original drive signal at a high frequency region to generate a modulation signal;
a transistor that amplifies the modulation signal to generate an amplified modulation signal;
a filter circuit that smooths the amplified modulation signal to generate a drive signal;
an ejection unit that is subjected to an ejection operation by the drive signal to eject liquid droplets; and
a substrate on which at least the transistor is disposed,
wherein through-holes are formed in the substrate in a region in which the transistor is disposed.
